(19) United States
(12) Patent Application Publication
(10) Pub. No.: US 2024/0232869 A9
(43) Pub. Date: Jul. 11, 2024

(54) METHODS AND SYSTEMS FOR PROVIDING A TOKENIZED PLATFORM WITH RESERVE

(71) Applicant: First Global Reserve, LLC (dba Numium), New York, NY (US)

(72) Inventors: Paul Carl Schorr, IV, New York, NY (US); Reha Hayrettin Kocatas, New York, NY (US)

(21) Appl. No.: 18/198,622

(22) Filed: May 17, 2023

Related U.S. Application Data
(60) Provisional application No. 63/343,525, filed on May 18, 2022.

(51) Int. Cl. G06Q 20/38; G06Q 40/04

(52) U.S. Cl. CPC G06Q 20/3825; G06Q 40/04

(57) ABSTRACT

A computer-implemented system uses a distributed ledger for providing a tokenized platform collateralized by asset-based reserves. The system provides a central entity that stores respective quantities of a plurality of instruments. The central entity is coupled to a distributed network of nodes that persistently store transaction data based on a token value. Processing circuitry of the central entity calculates a token value based on respective quantities of the plurality of instruments and updates a token value based on information received by servers at the central entity. The token value is provided to one or more nodes of the distributed network for use in a transaction. In some embodiments, in response to providing the value of the token, a buyer purchases a right to the token over the distributed network, and in response to the right to the token being purchased, the central entity allocates reserve assets collateralizing the token.

### CROSS-REFERENCE TO RELATED APPLICATIONS

The present application claims priority to U.S. Provisional Patent Application No. 63/343,525, filed on May 18, 2022, which is hereby incorporated by reference herein in its entirety.

### BACKGROUND

The present disclosure generally relates to communications systems, network infrastructures, and processing systems for use in providing a tokenized platform with reserve.

### SUMMARY

In accordance with one aspect of the present disclosure, a computer-implemented method performed by a central entity is provided for coordinating data exchange between entities on a distributed network of nodes that persistently store transaction data based on a value of a token associated with the distributed network. The central entity is coupled to the distributed network. Storage equipment at the central entity stores respective quantities for a plurality of instruments. A plurality of servers receives information about the plurality of instruments over one or more data communication channels. Processing circuitry calculates a value of the token based on the respective quantities of the plurality of instruments and on the information. The plurality of servers also receives updated information about the plurality of instruments over the one or more data communication channels. The processing circuitry also updates the value of the token based on the updated information. The value of the token is provided to one or more nodes of the distributed network for use in a transaction.

In another aspect of the present disclosure, storing the quantities for the instrument of the plurality of instruments includes storing a quantity of zero for a respective instrument of the plurality of instruments.

In yet another aspect of the present disclosure, the central entity includes at least one node of the distributed network of nodes.

In yet another aspect of the present disclosure, the plurality of instruments includes at least two of: currency, commodities, securities, tangible assets, asset-backed cryptocurrencies, or any combination thereof.

In yet another aspect of the present disclosure, the information about the plurality of instruments includes a market value associated with at least one of the plurality of instruments.

In yet another aspect of the present disclosure, respective quantities for the plurality of instruments are determined.

In yet another aspect of the present disclosure, a plurality of underlying assets collateralizing the token is monitored with respect to ensuring that a reserve requirement of the token is satisfied.

In yet another aspect of the present disclosure, receiving of the information includes receiving the information from sources in different time zones, and calculating the token value is also based on the sources in different time zones.

In yet another aspect of the present disclosure, the value of the token is particular to the respective plurality of instruments.

In yet another aspect of the present disclosure, the central entity creates multiple instances of a plurality of instruments.

In yet another aspect of the present disclosure, one or more tokens are associated with the plurality of instruments.

In yet another aspect of the present disclosure, the updated information received for a plurality of instruments causes a change of the respective quantities of the plurality of instruments and, in response to changing the respective quantities of the plurality of instruments, causes an automatic change of the reserve assets collateralizing the token.

In yet another aspect of the present disclosure, the central entity is located on at least one of a private or public distributed network of nodes.

In yet another aspect of the present disclosure, the token is of a first type and the method also includes exchanging other tokens of a second type for tokens of the first type based on an associated exchange rate.

In yet another aspect of the present disclosure, the token is redeemable for the plurality of instruments.

In yet another aspect of the present disclosure, the token is redeemable for an equivalent value in units of a single instrument that may or may not be in the plurality of instruments.

In yet another aspect of the present disclosure, in response to providing the value of the token, a buyer purchases a right to the token over the distributed network, and in response to the right to the token being purchased, the central entity allocates reserve assets collateralizing the token.

In accordance with another aspect of the present disclosure, a system is provided for coordinating data exchange between entities on a distributed network of nodes that persistently store transaction data based on a value of a token associated with the distributed network, and the system is coupled to the distributed network. The system includes storage equipment for storing respective quantities for a plurality of instruments. The system also includes a transceiver for receiving, from a plurality of servers over one or more data communication channels, information about the plurality of instruments. The system also includes processing circuitry for calculating a value of the token based on the respective quantities of the plurality of instruments and on the information. The transceiver is also used for receiving, from the plurality of servers over the one or more data communication channels, updated information about the plurality of instruments. The processing circuitry is also used for updating the value of the token based on the updated information, and providing the value of the token to one or more nodes of the distributed network for use in a transaction.

In another aspect of the present disclosure, the processing circuitry is also used for determining a quantity for an instrument of the plurality of instruments, including determining a quantity of zero for the instrument.

In yet another aspect of the present disclosure, the system for coordinating data exchange includes at least one node of the distributed network of nodes.

In yet another aspect of the present disclosure, the plurality of instruments includes at least two of: currency, commodities, securities, tangible assets, asset-backed cryptocurrencies, or any combination thereof.

In yet another aspect of the present disclosure, the information includes a market value associated with at least one of the plurality of instruments.

In yet another aspect of the present disclosure, the processing circuitry is also used for determining the quantities for the plurality of instruments.

In yet another aspect of the present disclosure, the processing circuitry is also used for monitoring a plurality of underlying assets collateralizing the token with respect to ensuring that a reserve requirement of the token is satisfied.

In yet another aspect of the present disclosure, the instruments are associated with different time zones and the processing circuitry is used for calculating the value of the token based on the different time zones

In yet another aspect of the present disclosure, the value of the token is particular to the respective plurality of instruments.

In yet another aspect of the present disclosure, the distributed network of nodes stores multiple instances of a plurality of instruments.

In yet another aspect of the present disclosure, one or more tokens are associated with the plurality of instruments.

In yet another aspect of the present disclosure, the processing circuitry causes a change of the respective quantities of the plurality of instruments and, in response to changing the respective quantities of the plurality of instruments, causes an automatic change of the reserve assets collateralizing the token.

In yet another aspect of the present disclosure, the distributed network of nodes is located on at least one of a private or public distributed network of nodes.

In yet another aspect of the present disclosure, the token is of a first type and the system also includes exchanging other tokens of a second type for tokens of the first type based on an associated exchange rate.

In yet another aspect of the present disclosure, the token is redeemable for the plurality of instruments.

In yet another aspect of the present disclosure, the token is redeemable for an equivalent value in units of a single instrument that may or may not be in the plurality of instruments.

In yet another aspect of the present disclosure, in response to providing the value of the token, a buyer purchases a right to the token over the distributed network, and in response to the right to the token being purchased, the central entity allocates reserve assets collateralizing the token.

In accordance with another aspect of the present disclosure, a non-transitory computer readable medium having instructions programmed thereon is provided for performing a method for coordinating data exchange between entities on a distributed network of nodes that persistently store transaction data based on a value of a token associated with the distributed network, with the central entity coupled to the distributed network. The method includes storing respective quantities for a plurality of instruments. The method also includes receiving, from a plurality of servers over one or more data communication channels, information about the plurality of instruments. The method also includes calculating the value of the token based on the respective quantities of the plurality of instruments and on the information. The method also includes receiving, from the plurality of servers over the one or more data communication channels, updated information about the plurality of instruments. The method also includes updating the value of the token based on the updated information. The method also includes providing the value of the token to one or more nodes of the distributed network for use in a transaction.

In another aspect of the present disclosure, the determining a quantity for an instrument of the plurality of instruments includes determining a quantity of zero for the instrument.

In yet another aspect of the present disclosure, the central entity includes at least one node of the distributed network of nodes.

In yet another aspect of the present disclosure, the plurality of instruments includes at least two of: currency, commodities, securities, tangible assets, asset-backed cryptocurrencies, or any combination thereof.

In yet another aspect of the present disclosure, the information about the plurality of instruments includes a market value associated with at least one of the plurality of instruments.

In yet another aspect of the present disclosure, the method also includes determining the quantities for the plurality of instruments.

In yet another aspect of the present disclosure, the method also includes monitoring a plurality of underlying assets collateralizing the token with respect to ensuring that a reserve requirement of the token is satisfied.

In yet another aspect of the present disclosure, the receiving of the information includes receiving the information from sources in different time zones, and the calculating of the value of the token is also based on different time zones.

In yet another aspect of the present disclosure, the value of the token is particular to the respective plurality of instruments.

In yet another aspect of the present disclosure, the distributed network of nodes stores multiple instances of a plurality of instruments.

In yet another aspect of the present disclosure, one or more tokens are associated with the plurality of instruments.

In yet another aspect of the present disclosure, the updated information received for a plurality of instruments causes a change of the respective quantities of the plurality of instruments and, in response to changing the respective quantities of the plurality of instruments, causes an automatic change of the reserve assets collateralizing the token.

In yet another aspect of the present disclosure, the distributed network of nodes is located on at least one of a private or public distributed network of nodes.

In yet another aspect of the present disclosure, the token is of a first type and the medium also includes exchanging other tokens of a second type for tokens of the first type based on an associated exchange rate.

In yet another aspect of the present disclosure, the token is redeemable for the plurality of instruments.

In yet another aspect of the present disclosure, the token is redeemable for an equivalent value in units of a single instrument that may or may not be in the plurality of instruments.

In yet another aspect of the present disclosure, in response to providing the value of the token, a buyer purchases a right to the token over the distributed network, and in response to the right to the token being purchased, the central entity allocates reserve assets collateralizing the token.

In accordance with another aspect of the present disclosure, a computer-implemented method performed by a central entity on a distributed network of nodes is provided for persistently storing transaction data based on a token value associated with the distributed network, and the central entity is coupled to the distributed network. The method includes receiving, by the central entity a request associated with an account to issue or redeem at least a portion of a token having a token value, wherein the token value is based on a plurality of instruments and respective quantities. The method also includes determining an amount of payment based on the token value. The method also includes causing to be transferred, by processing circuitry at the central entity, the amount of payment to the account. The method also includes causing the distributed network of nodes to be updated based on the payment.

In another aspect of the present disclosure, the method also includes, when the at least a portion of the token includes a fraction of the token, adding a value indicative of the fraction to a fractionalized token count. The method also includes, after the fractionalized token count amounts to a full token, reducing the count by one, and causing to be updated the distributed network of nodes, including causing to be updated the distributed network of nodes to store information indicative of one token being issued or redeemed.

In yet another aspect of the present disclosure, the causing to transfer the amount of payment to the account includes causing to transfer at least one of the plurality of instruments amounting to the amount of payment.

In yet another aspect of the present disclosure, the quantities for the instrument of the plurality of instruments includes a quantity of zero for a respective instrument of the plurality of instruments.

In yet another aspect of the present disclosure, the central entity includes at least one node of the distributed network of nodes.

In yet another aspect of the present disclosure, the plurality of instruments includes at least two of: currency, commodities, securities, tangible assets, asset-backed cryptocurrencies, or any combination thereof.

In yet another aspect of the present disclosure, the information about the plurality of instruments includes a market value associated with at least one of the plurality of instruments.

In yet another aspect of the present disclosure, the method also includes determining the quantities for the plurality of instruments.

In yet another aspect of the present disclosure, the method also includes monitoring a plurality of underlying assets collateralizing the token with respect to ensuring that a reserve requirement of the token is satisfied.

In yet another aspect of the present disclosure, the receiving of the information includes receiving the information from sources in different time zones, and the calculating is also based on different time zones.

In yet another aspect of the present disclosure, the value of the token is particular to the respective plurality of instruments.

In yet another aspect of the present disclosure, the central entity creates multiple instances of a plurality of instruments.

In yet another aspect of the present disclosure, one or more tokens are associated with the plurality of instruments.

In yet another aspect of the present disclosure, the updated information received for a plurality of instruments causes a change of the respective quantities of the plurality of instruments and, in response to changing the respective quantities of the plurality of instruments, causes an automatic change of the reserve assets collateralizing the token.

In yet another aspect of the present disclosure, the central entity is located on at least one of a private or public distributed network of nodes.

In yet another aspect of the present disclosure, the token is redeemable for the plurality of instruments.

In yet another aspect of the present disclosure, the token is redeemable for an equivalent value in units of a single instrument that may or may not be in the plurality of instruments.

In yet another aspect of the present disclosure, in response to providing the value of the token, a buyer purchases a right to the token over the distributed network, and in response to the right to the token being purchased, the central entity allocates reserve assets collateralizing the token.

In accordance with another aspect of the present disclosure, a system coupled to a distributed network of nodes is provided for persistently storing transaction data based on a token value associated with the distributed network. The system includes a transceiver for receiving a request associated with an account to issue or redeem at least a portion of a token having the token value, wherein the token value is based on a plurality of instruments and respective quantities. The system also includes processing circuitry configured for determining an amount of payment based on the token value, causing to be transferred the amount of payment to the account, and causing to be updated the distributed network of nodes based on the payment.

In another aspect of the present disclosure, the processing circuitry is also configured for, when the at least a portion of the token includes a fraction of the token, adding a value indicative of the fraction to a fractionalized token count, and, after the fractionalized token count amounts to a full token, reducing the count by one and causing to be updated the distributed network of nodes to store information indicative of one token being issued or redeemed.

In yet another aspect of the present disclosure, the processing circuitry is also configured for causing to be transferred at least one of the plurality of instruments amounting to the amount of payment.

In yet another aspect of the present disclosure, the quantities for the instrument of the plurality of instruments include a quantity of zero for a respective instrument of the plurality of instruments.

In yet another aspect of the present disclosure, the system includes at least one node of the distributed network of nodes.

In yet another aspect of the present disclosure, the plurality of instruments includes at least two of: currency, commodities, securities, tangible assets, asset-backed cryptocurrencies, or any combination thereof.

In yet another aspect of the present disclosure, the information about the plurality of instruments includes a market value associated with at least one of the plurality of instruments.

In yet another aspect of the present disclosure, the system coupled to the distributed network of nodes also includes determining the quantities for the plurality of instruments.

In yet another aspect of the present disclosure, the system coupled to the distributed network of nodes also includes monitoring a plurality of underlying assets collateralizing the token with respect to ensuring that a reserve requirement of the token is satisfied.

In yet another aspect of the present disclosure, the transceiver is also used for receiving information including information from sources in different time zones, and the processing circuitry is also used for calculating the value of the token based on different time zones.

In yet another aspect of the present disclosure, the value of the token is particular to the respective plurality of instruments.

In yet another aspect of the present disclosure, the system coupled to the distributed network of nodes creates multiple instances of a plurality of instruments.

In yet another aspect of the present disclosure, one or more tokens are associated with the plurality of instruments.

In yet another aspect of the present disclosure, the updated information received for a plurality of instruments causes a change of the respective quantities of the plurality of instruments and, in response to changing the respective quantities of the plurality of instruments, causes an automatic change of the reserve assets collateralizing the token.

In yet another aspect of the present disclosure, the system coupled to the distributed network of nodes is located on at least one of a private or public distributed network of nodes.

In yet another aspect of the present disclosure, the token is redeemable for the plurality of instruments.

In yet another aspect of the present disclosure, the token is redeemable for an equivalent value in units of a single instrument that may or may not be in the plurality of instruments.

In yet another aspect of the present disclosure, in response to determining an amount of payment, a buyer purchases a right to the token over the distributed network, and in response to the right to the token being purchased, the central entity allocates reserve assets collateralizing the token.

In accordance with another aspect of the present disclosure, a non-transitory computer readable medium having instructions stored thereon is provided that, when executed, performs a method by a central entity on a distributed network of nodes that persistently store transaction data based on a token value associated with the distributed network, and the central entity is coupled to the distributed network. The method includes receiving, by the central entity a request associated with an account to issue or redeem at least a portion of a token having a token value, wherein the token value is based on a plurality of instruments and respective quantities. The method also includes determining, an amount of payment based on the token value, causing to be transferred, the amount of payment to the account, and causing to be updated, the distributed network of nodes based on the payment.

In another aspect of the present disclosure, the method also includes, when at least a portion of the token includes a fraction of the token, adding a value indicative of the fraction to a fractionalized token count, and, after the fractionalized token count amounts to a full token, reducing the count by one, wherein causing to be updated the distributed network of nodes includes causing to be updated the distributed network of nodes to store information indicative of one token being issued or redeemed.

In yet another aspect of the present disclosure, the method causing the transfer of the amount of payment to the account includes causing to be transferred at least one of the plurality of instruments amounting to the amount of payment.

In yet another aspect of the present disclosure, the storing the quantities for the instrument of the plurality of instruments includes storing a quantity of zero for a respective instrument of the plurality of instruments.

In yet another aspect of the present disclosure, the central entity includes at least one node of the distributed network of nodes.

In yet another aspect of the present disclosure, the plurality of instruments includes at least two of: currency, commodities, securities, tangible assets, asset-backed cryptocurrencies, or any combination thereof.

In yet another aspect of the present disclosure, the information about the plurality of instruments includes a market value associated with at least one of the plurality of instruments.

In yet another aspect of the present disclosure, the method also includes determining the quantities for the plurality of instruments.

In yet another aspect of the present disclosure, the method also includes monitoring the value of the token with respect to reserve assets collateralizing the token.

In yet another aspect of the present disclosure, the information associated with the token value includes information from sources in different time zones, and wherein the calculating the value of the token is also based on different time zones.

In yet another aspect of the present disclosure, the value of the token is particular to the respective plurality of instruments.

In yet another aspect of the present disclosure, the central entity creates multiple instances of a plurality of instruments.

In yet another aspect of the present disclosure, one or more tokens are associated with the plurality of instruments.

In yet another aspect of the present disclosure, the updated information received for a plurality of instruments causes a change of the respective quantities of the plurality of instruments and, in response to changing the respective quantities of the plurality of instruments, causes an automatic change of the reserve assets collateralizing the token.

In yet another aspect of the present disclosure, the central entity is located on at least one of a private or public distributed network of nodes.

In yet another aspect of the present disclosure, the token is redeemable for the plurality of instruments.

In yet another aspect of the present disclosure, the token is redeemable for an equivalent value in units of a single instrument that may or may not be in the plurality of instruments.

In yet another aspect of the present disclosure, in response to determining the amount of payment, a buyer purchases a right to the token over the distributed network, and in response to the right to the token being purchased, the central entity allocates reserve assets collateralizing the token.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 is an illustrative block diagram showing a system for providing a tokenized platform with reserve, in accordance with some embodiments of the disclosure;

FIG. 2 is an illustrative block diagram showing an example of a central entity for providing a tokenized platform with reserve, in accordance with some embodiments of the disclosure;

FIG. 3 is an illustrative block diagram showing another example of a central entity for providing a tokenized platform with reserve, in accordance with some embodiments of the disclosure;

FIG. 4 is an illustrative block diagram showing yet another example of a central entity for providing a tokenized platform with reserve, in accordance with some embodiments of the disclosure;

FIG. 5 is an illustrative block diagram showing an example of a pricing engine, in accordance with some embodiments of the disclosure;

FIG. 6 is an illustrative block diagram showing an example of a token valuation, in accordance with some embodiments of the disclosure;

FIG. 7 is an illustrative block diagram showing an example of token exchange rates, in accordance with some embodiments of the disclosure;

FIG. 8 is an illustrative flowchart of a process for providing a tokenized platform with reserve, in accordance with some embodiments of the disclosure;

FIG. 9 is an illustrative flowchart of another process for providing a tokenized platform with reserve, in accordance with some embodiments of the disclosure;

FIG. 10 is an illustrative flowchart of a process for handling a token issuance or redemption request, in accordance with some embodiments of the disclosure;

FIG. 11 is an illustrative flowchart of another process for handling a token issuance or redemption request, in accordance with some embodiments of the disclosure;

FIG. 12 is an illustrative flowchart of a process for determining the ability to execute a token issuance request, in accordance with some embodiments of the disclosure; and

FIG. 13 is an illustrative flowchart of a process for redemption of a fractional token, in accordance with some embodiments of the disclosure.

### DETAILED DESCRIPTION

Modern networks and systems commonly face problems of tokens on distributed networks of nodes (e.g., blockchains) having no intrinsic value or basis for valuation, as such tokens do not ordinarily represent ownership of any real-world assets (“Untethered Tokens”); and, as such, they have limited to no ability to be used for real-world transactions. Untethered Tokens typically cannot be valued based on any real-world asset-based metrics, and instead can typically only be valued based on speculation and the perception of some projected future value, which, again, is not based on any real-world asset-based metrics. Market exchanges have shown that these problematic attributes can result in highly volatile token prices, problematic exchange rates, and liquidity issues—all of which limit the ability and desirability of Untethered Tokens to be used for commerce transactions. (The terms “tokens” and “coins” are used interchangeably herein.)

In some embodiments, systems are provided to enable certain tokens to be reliably valued by making them representative of ownership in real-world assets, without actual ownership of the real-world assets. These tokens may be issued by an authority that causes the respective token to track a given real-world asset, but does not collateralize the token ownership with corresponding real-world asset ownership. However, such simplified tokens have limitations and issues that dramatically reduce their ability to become universal payment solutions and asset protection vehicles, such as being respectively tied to single assets, including no collateralization of the token, and therefore offering no more security of value, while retaining all of the risks, of the underlying respective asset. Moreover, on the payment side, these simple tokens are analogous to stored value cards (having only the value of their respective underlying asset), making them incapable of serving universal payment applications.

In some embodiments, modern networks and systems face additional problems of protecting token ownership. Tokens are often tethered to identifying codes, i.e., private keys, which are stored in a digital system often referred to as a “Wallet.” If a token owner's Wallet and/or private keys are lost, hacked, or otherwise compromised, the token owner may effectively lose ownership of their tokens. While broader systems have developed to allegedly safeguard Wallets, there remains no mechanism, such as insurance, for protecting the ownership of tokens in the event that the private key is compromised.

To solve these problems, a system is needed to provide a token capable of real-time valuation and pricing, and of liquid convertibility into a myriad of currencies and financial instruments. A token with these characteristics can be transparently valued by anyone at any time (i.e., it has intrinsic value). Such tokens may be used for commerce because both their buyer and seller can be confident in their value, both at the time of Exchange and into the future. A system is also needed to execute functions supporting token ownership and transactions, including market coordination, token valuation, token insurance, and more.

In some embodiments, a buyer can Exchange different financial instruments (e.g., US Dollars, Gold, Silver, Euros, Norwegian Krona, Swiss Francs, Australian Dollars, Singapore Dollars, British Pounds, other global currencies, asset-backed cryptocurrencies, or commodities) to purchase tokens created by the central entity and collateralized by Reserves held therein. Tokens may be converted back to these financial instruments, or other financial instruments. The tokens may be transparently and dynamically valued based on an underlying basket of financial instruments. In some embodiments, the basket can be rebalanced by the central entity at any time for any number of reasons, e.g., to protect against devaluations or quantitative easing by governments, to hedge against inflation, to stabilize the security of the central entity and tokens held therein, or for other reasons. In some embodiments, Reserves, transaction fees and processing fees can be stored to provide liquidity to ensure orderly conversions and reliable ownership.

In some embodiments, the system will allow for the valuation and pricing, the issuance by a central entity (“Issuance”), the redemption by a central entity (“Redemption”), and the exchange between two or more third-parties (“Exchange”) of one or more unique types of tokens (or fractional tokens) that are collateralized by a reserve (“Reserve”) of underlying highly-liquid and globally-traded currencies, commodities, asset-backed cryptocurrencies and/or other assets. Issuances, Redemptions and Exchanges are sometimes collectively referred to as “Transactions.” In some embodiments, Transactions include one or more Unique Tokens being exchanged for fiat currency or for other Unique Tokens. In some embodiments, a central entity may manage, coordinate, facilitate, handle, or otherwise enable all Transactions and all Reserves.

In some embodiments, a central entity may execute new token basket design, including the selection of a plurality of instruments and the respective quantities thereof, and integrate with third-party stakeholders for Issuance, Redemption, Exchange, and Reserve functions. A given third-party stakeholder may hold tokens specifically designed for the given third-party stakeholder, and such tokens may be referred to as third-party tokens. Subsequent to Issuance, a central entity may maintain the dynamic token valuation and inform third-party stakeholders on the requisite Reserve, as described above and as also described below. Third-party stakeholders may hold the Reserve and may facilitate Redemption and Exchange. These actions executed by the third-party stakeholders may be on behalf of their own Redemption and Exchange of the tokens, or they may be executed in a custodial capacity, e.g., on behalf of their own clients. A central entity may design a Unique Token expressly for a given third-party stakeholder.

To enable the system to value tokens and facilitate Transactions, the system will source and/or maintain information from, and with respect to, multiple global market exchanges. Such information may include, among other things, information regarding exchange rates, trading volume, operating hours of the exchanges, connectivity, and so on.

Unique Tokens: In some embodiments, the primary parameters of each unique type of token are its “Asset Mix” (as defined below) and its “Reserve Requirement” (as defined below).

Asset Mix: In some embodiments, each unique type of token will be associated with a distinctly preconfigured underlying basket comprised of a pre-designated mix of multiple highly-liquid and globally-traded currencies, commodities, asset-backed cryptocurrencies, and/or other assets (each, an “Underlying Asset”), with a pre-designated and potentially different (and potentially fractional) number of units of each such Underlying Asset being contained in the basket (“Asset Mix”). In some embodiments, any financial instrument or other value-retaining asset may be an Underlying Asset. For example, the Asset Mix for a unique type of token might be 100 US Dollars, 64 Euros, and 0.044 ounces of Gold. In some embodiments, the Asset Mix associated with each unique type of token may be modified, as discussed herein.

Reserve Requirement: In some embodiments, each unique type of token will be associated with a pre-designated “Reserve Requirement,” which is the pre-designated minimum Reserve assets that is required to be held in order to, among other functions, collateralize the central entity's obligations with respect to that token. In some embodiments, one or more third-party stakeholders hold some or all of the Reserve assets.

In some embodiments, the Reserve Requirement for any given unique type of token may mandate that a predesignated percentage number (a “Reserve Percentage”) be applied to determine the number (or fractional number) of units of that token's Underlying Assets that must be held in Reserve. If, for example, the Reserve Requirement for any given unique type of token were to mandate a fixed Reserve Percentage of 25%, and that token's Asset Mix were to be as set forth above, then a minimum of 25 US Dollars (25% of 100 US Dollars), 16 Euros (25% of 64 Euros), and 0.011 ounces of Gold (25% of 0.044 ounces of Gold) would need to be held in Reserve, among other things, to collateralize the central entity's obligations with respect to that token. The Reserve Requirement may dynamically update according to real-time information from the multiple global market exchanges and real-time information regarding the token value and quantity of outstanding issued tokens, among other information. In some embodiments, the Reserve Percentage may be 100%.

In some embodiments, the Reserve Requirement may mandate, with respect to any given unique type of token, that different Reserve Percentages be applied to different tranches of tokens that are outstanding. For example, with respect to any given unique type of token, the Reserve Requirement may mandate that a Reserve Percentage of 30% be applied to the first 1 million tokens that are outstanding, that a Reserve Percentage of 17.5% be applied to the next 10 million tokens that are outstanding, and that a Reserve Percentage of 5% be applied to all additional tokens that are outstanding. The Reserve Percentages of the preceding examples may also depend on the value of each unique type of token. For example, the Reserve Percentage for any tranche of outstanding tokens may reduce if the token value increases, and these same Reserve Percentages may increase if the token value reduces.

In some embodiments, different Reserve Percentages may also be applied to each Underlying Asset within the Asset Mix. If, for example, the Reserve Requirement were to vary for each Underlying Asset within the Asset Mix as set forth above, a Reserve Percentage of 30% may be applied to the US Dollars, a Reserve Percentage of 17.5% may be applied to the Euros, and a Reserve Percentage of 5% may be applied to the Gold.

In some embodiments, there will be multiple unique types of tokens, each with its own branded name, and each characterized by its own unique Asset Mix and Reserve Requirement. Each such unique type of token is referred to as a “Unique Token.” Each such Unique Token may be designed to accommodate specific goals of the token holder, e.g., stability against inflation, growth in value, protection against certain market dynamics, or for other financial reasons.

Valuing Unique Tokens: In some embodiments, the system will provide the real-time value of each Unique Token, denominated in units of other assets. The real-time value of each Unique Token may depend on dynamic market information that is retrieved and incorporated by the system.

“Denominated Quoted Token Value” means the value of a Unique Token as denominated in units of another asset (while, more generally, “Denominated Quoted Value” means the value of any given asset as denominated in units of another asset). “Denominated Quoted Asset” means the asset in whose units any value is being denominated. As one example of how some of the above terms may be used, the Denominated Quoted Token Value of one “Numi” token may be 100 US Dollars, 96 Euros, or 0.0551907 ounces of Gold. In this example, the Denominated Quoted Asset is the US Dollar, Euro, or Gold, respectively. In some embodiments, the Denominated Quoted Token Value and the Denominated Quoted Asset are used by the central entity and/or the token holders to facilitate Exchanges (e.g., to make a token market). In some embodiments, the values as described by the above terms may depend on the dynamic market information that is retrieved and incorporated by the system.

In some embodiments, the system's valuation and pricing engine will automatically determine the Denominated Quoted Token Value for any Unique Token, as expressed in units of any given Denominated Quoted Asset, by: (i) collecting and processing exchange rates with respect to the Denominated Quoted Asset, on the one hand, and each of the Underlying Assets for that Unique Token, on the other hand; (ii) applying those exchange rates to determine the Denominated Quoted Value of each of those Underlying Assets; and (iii) adding all resulting amounts together in order to determine the Denominated Quoted Value of that Unique Token's entire Asset Mix, and thus the Denominated Quoted Token Value of that Unique Token.

The following is a representative discussion of a process for Collecting and Processing Exchange Rates with Respect to the Denominated Quoted Asset and/or each of the Underlying Assets for that Unique Token, to better contextualize step (i) as described above. As discussed in step (i) above, as one of the first steps in determining the Denominated Quoted Token Value for any Unique Token, as expressed in units of any given Denominated Quoted Asset, the system's valuation and pricing engine will collect and process exchange rates with respect to the Denominated Quoted Asset, on the one hand, and each of the Underlying Assets for that Unique Token, on the other hand.

As used herein, the following terms have the meanings set forth below:
“Asset Pair” means the pairing of any two assets that are maintained in the system. For example, the US Dollar and the Euro might be one Asset Pair.
When one wishes to determine the value of one asset, as denominated in units of another asset, the asset one is valuing is referred to as the “Base Asset.” As discussed above, the asset in whose units the value of the Base Asset is being denominated is the “Denominated Quoted Asset.” For example, if one wished to determine the value of one Euro in US Dollars, the Euro would be the Base Asset, while the US Dollar would be the Denominated Quoted Asset.
“Exchange Pair” means the one-directional pairing of the two assets in any Asset Pair, which can be used, among other times, when one wishes to determine the exchange rate for valuing a Base Asset in units of a Denominated Quoted Asset. For any Asset Pair, there will be the following two Exchange Pairs: (A) one Exchange Pair in which one of the two assets is the Base Asset and the other is the Denominated Quoted Asset; and (B) a second Exchange Pair in which the Base Asset from the first Exchange Pair is instead the Denominated Quoted Asset, and in which the Denominated Quoted Asset from the first Exchange Pair is instead the Base Asset. For example, with respect to an Asset Pair consisting of the US Dollar and the Euro, the two Exchange Pairs would be: (A) Euro (Base Asset)—US Dollar (Denominated Quoted Asset); (B) US Dollar (Base Asset)—Euro (Denominated Quoted Asset).

In some embodiments, the system will maintain each Exchange Pair for every Asset Pair.

In some embodiments, the system will determine the real-time exchange rate for each Exchange Pair based on information that it is able to access, e.g., from the multiple global market exchanges. When the system is able to access information from the multiple global market exchanges at the time of determination, and such global market exchanges offer different real-time exchange rates for any given Exchange Pair, the system will use the real-time exchange rate that would yield the largest amount of the Denominated Quoted Asset in Exchange for the Base Asset in question.

Based on the above, the system's valuation and pricing engine will be able to value any one asset in denominated units of any other asset, provided that the system is able to determine the exchange rate with respect to the applicable Asset Pair from global markets.

For example, the system will be able to value any number of Euros in denominations of dollars (and might hypothetically determine that the exchange rate used to determine the value of 1 Euro in US Dollars is 1.04), and the system will be able to value any number of British Pounds in denominations of dollars (and might hypothetically determine that the exchange rate used to determine the value of 1 British Pound in US Dollars is 1.23).

The following is a representative discussion of a process for Applying Exchange Rates to Determine the Denominated Quoted Value of the Underlying Assets of a Unique Token, to better contextualize step (ii) as described above. As discussed in subsection (ii) above, once the system's valuation and pricing engine has collected and processed exchange rates with respect to the Denominated Quoted Asset, on the one hand, and each of the Underlying Assets for a Unique Token, on the other hand, it will apply those exchange rates to determine the Denominated Quoted Value of each of those Underlying Assets.

Specifically, for each Underlying Asset with respect to the Unique Token in question, the system will multiply (a) the number of units of the Underlying Asset, times (b) the exchange rate used to value that specific Underlying Asset in units of the Denominated Quoted Asset. The product of each such calculation will yield the Denominated Quoted Value of each Underlying Asset in units of the Denominated Quoted Asset.

For example, if the Asset Mix for a Unique Token consisted exclusively of (a) 100 Euros and (b) 200 British Pounds, and if the US Dollar was the Denominated Quoted Asset in whose units the system sought to value the Underlying Assets, then the system would:
(a) multiply 100 (the number of Euros) times the exchange rate used to determine the value of 1 Euro in US Dollars, which might hypothetically be 1.04—thus yielding 104 US Dollars as the Denominated Quoted Value for the Underlying Asset of Euros; and
(b) multiply 200 (the number of British Pounds) times the exchange rate used to determine the value of 1 British Pound in US Dollars, which might hypothetically be 1.23—thus yielding 246 US Dollars as the Denominated Quoted Value for the Underlying Asset of British Pounds.

The following is a representative discussion of a process for Adding the Denominated Quoted Values of All Underlying Assets to Determine the Denominated Quoted Value of a Unique Token's entire Asset Mix, to better contextualize step (iii) as described above. As discussed in subsection (iii) above, once the system's valuation and pricing engine has determined the Denominated Quoted Value of each Underlying Asset for any given Unique Token, it will add all of those Denominated Quoted Values together to determine the Denominated Quoted Value of the entire Asset Mix for that Unique Token.

This Denominated Quoted Value of the entire Asset Mix will be the final Denominated Quoted Token Value, or the “Denominated Token Price,” of the Unique Token in question, as denominated in units of the Denominated Quoted Asset.

To illustrate, in the immediately preceding example, the system would add 104 US Dollars (as the Denominated Quoted Value for the Underlying Asset of British Pounds) and 246 US Dollars (as the Denominated Quoted Value for the Underlying Asset of British Pounds) to determine that the Denominated Quoted Value of the entire Asset Mix of the Unique Token was 350 US Dollars. Consequently, the system would determine that the Denominated Quoted Token Value, or the “Denominated Token Price”, of the Unique Token was 350 US Dollars. The system may use this value, in coordination with the central entity and/or the token holders, to facilitate token purchasing or Redemption.

The following is a representative discussion of a process for Pricing Transactions. In some embodiments, once the Denominated Token Price of a Unique Token has been determined, as denominated in units of the Denominated Quoted Asset, the system's valuation and pricing engine will determine: (i) the total number of tokens (or fractional tokens) to be Issued to a buyer in Exchange for any given amount of consideration (the “Denominated Total Consideration”), and (ii) the Denominated Total Consideration to be tendered to a seller in connection with the Redemption of any given number (or fractional number) of tokens.

Issuances: An Issuance may include a completed token design, including its underlying Asset Mix and Reserve Requirement. In some embodiments, an Issuance may also include an initial sale of the tokens to token buyers, with this aspect of the Issuance possibly performed by or in coordination with a third-party stakeholder (e.g., acting as an administrative entity controlling a part of the central entity). For any Issuance of tokens by a central entity, the exact number of tokens (or fractional tokens) that a buyer will receive is equal to the result obtained by dividing (a) the Denominated Total Consideration to be paid by the buyer, by (b) the Denominated Token Price, each such amount (a) and (b) to be denominated in units of the Denominated Quoted Asset. For example, if the Denominated Total Consideration to be paid by the buyer is 100 Euros, and if the Denominated Token Price is 400 Euros, then the buyer will receive exactly 0.25 tokens in the Transaction (100 Euros/400 Euros=0.25 tokens). With respect to the buyer, the Denominated Total Consideration may not be inclusive of additional costs, including Fees as further discussed below.

Redemptions: For any Redemption of tokens by a central entity, the exact Denominated Total Consideration that a seller will receive is equal to the result, as denominated in units of the Denominated Quoted Asset, obtained by multiplying (a) the exact number of tokens (or fractional tokens) to be tendered by the seller, times (b) the Denominated Token Price, as denominated in units of the Denominated Quoted Asset. For example, if exactly 0.25 tokens will be tendered by the seller, and if the Denominated Token Price is 400 Euros, then the seller will receive exactly 100 Euros in the Transaction (0.25 tokens×400 Euros=100 Euros). With respect to the seller, the Denominated Total Consideration may not be inclusive of additional costs, including Fees as further discussed below.

Choosing the Denominated Quoted Asset: In some embodiments, the party transacting with the central entity will be permitted to Choose the Denominated Quoted Asset, i.e., to determine the exact asset type that will be tendered in consideration for tokens, whether the Transaction involves the party tendering units of that asset type to the central entity in consideration for the Issuance of tokens by the central entity, or whether the Transaction involves the central entity tendering units of that asset type to the party in consideration for the Redemption of tokens by the central entity—provided, in all cases, that the asset type the party wishes to use is on a preconfigured list of forms of consideration that the system deems acceptable.

Fees: In some embodiments, the system may charge certain fees, including Transaction fees. In some embodiments, such fees will be separate from, and not impact, any valuing of tokens, or any pricing of Transactions.

Modifying or Rebalancing the Asset Mix of any Unique Token: In some embodiments, the system may allow the central entity to modify or rebalance the Asset Mix of any Unique Token. In some embodiments, any such modifications or rebalancings will be done in such a manner as to maintain the aggregate market value of the Unique Token's Asset Mix, as denominated in the units of any Denominated Quoted Asset. In some embodiments, the modifications or rebalancings may serve to maintain Reserve Requirements of the Unique Token and/or the Reserve Percentages of the Underlying Assets. In some embodiments, rebalancing may automatically change the Reserve assets collateralizing the Unique Token

Maintaining the Minimum Aggregate Reserve: In some embodiments, the system will, at all times, automatically determine and maintain the minimum aggregate Reserve of Underlying Assets that must be held in Reserve to, among other things, collateralize the central entity's obligations with respect to entire outstanding float for any given Unique Token, in accordance with the Reserve Requirement for that Unique Token. In some embodiments, the system will automatically determine and maintain the Reserve in response to the information that it is able to access, e.g., from the multiple global market exchanges. The Reserve Requirement for any Unique Token may depend on the entire outstanding float of that Unique Token, the entire outstanding float calculated as the product of (a) the Unique Token value times (b) the total number of outstanding Unique Tokens.

In some embodiments, when there are any Issuances of a Unique Token, thereby increasing the minimum aggregate amount of Underlying Assets that must be held in Reserve with respect to that Unique Token, the system may automatically purchase, on one or more global market exchanges, the additional Underlying Assets that must be held in Reserve, or may otherwise automatically ensure that the Reserve meets the Reserve Requirement (e.g., by specifically allocating Reserve assets already managed by the system). In some embodiments, wherein a third-party stakeholder holds the Reserve, the system may automatically direct the third-party stakeholder to purchase the additional Underlying Assets that must be held in Reserve or otherwise ensure that the Reserve meets the Reserve Requirement. In some embodiments, when there are any Redemptions of a Unique Token, thereby decreasing the minimum aggregate amount of Underlying Assets that must be held in Reserve with respect to that Unique Token, the system may automatically sell, on one or more global market exchanges, the amount of Underlying Assets that no longer need to be held in Reserve by virtue of the Redemptions. In some embodiments, wherein a third-party stakeholder holds the Reserve, the system will automatically direct the third-party stakeholder to sell, on one or more global market exchanges, the additional Underlying Assets that no longer need to be held in Reserve. In some embodiments, the automatic purchases and/or sales of the system will be done in such a manner as to maintain the aggregate market value of the Unique Token's Asset Mix, as denominated in the units of any Denominated Quoted Asset. In some embodiments, any one or more of these functions for automatically updating the Reserve assets collateralizing a Unique Token may be executed by the central entity in response to changes in market conditions (e.g., changes in market value of the Unique Token and/or Underlying Assets thereof).

Third-Party Verification: In some embodiments, the system will provide certain Third-Party Verification services, e.g., by providing third parties with access to information regarding the total number of tokens that are outstanding for any given type of Unique Token, the Asset Mix for that type of Unique Token, the Reserve Requirement for that type of Unique Token, the aggregate Underlying Assets that are actually being held in Reserve with respect to that Unique Token, or other financial information. In some embodiments, the system will provide certain third-parties the ability to audit the foregoing information, and to certify that the required Reserve with respect to any given type of Unique Token is, in fact, being maintained. In some embodiments, certain third-party stakeholders may hold the Reserve with respect to a Unique Token, and in such instances, the central entity may retain the ability to audit these third-party stakeholders to certify that the required Reserve with respect to any given type of Unique Token is, in fact, being maintained. In some embodiments, the system may automatically modify or rebalance any of a Unique Token Reserve, an Asset Mix of a Unique Token, a Reserve Requirement of a Unique Token, the aggregate Underlying Assets that are actually being held in Reserve with respect to that Unique Token, or other financial instruments in response to the third-party audit.

Rounding: In some embodiments, the system will Round certain figures that contain too many digits to the right of any decimal point, according to rules that will be determined. Such rounding may occur with respect to a variety of types of figures, and it may affect a variety of calculations and other matters, including without limitation those involving token values and pricing.

Records: In some embodiments, the system will have the ability to post Records of all Issuances and Redemptions and certain Exchanges to a third-party system such as private and public blockchain ledgers or other forms of data storage. The configuration of posting to third-party external systems will be specified for each unique type of token that is configured. In some embodiments, the private and public blockchain ledgers may be stored within a central entity.

In some embodiments, the system will maintain a record with respect to certain Transactions, which record may include the following types of information:
Transaction IDs;
Information about digital wallets;
Information about the type of asset that was tendered in Transactions;
The quantity of the asset that was tendered in consideration for tokens;
The number of tokens (or fractional tokens) that were tendered in the Transaction;
The Asset Mix ID associated with the type of token that was tendered in the Transaction; and
Details regarding the required Reserve with respect to the tokens that were tendered in the Transaction.

In some embodiments, upon the occurrence of all Issuances and Redemptions, the system will record the above information to an internal ledger that maintains a running total calculation of the total number of the applicable type of token that are then in circulation. The internal ledger may be replicated on a public blockchain, or it may be replicated on a private blockchain.

Operating the System: In some embodiments, a central entity will Operate the System. In some embodiments, third-party stakeholders may control part of the central entity and therein Operate the System in part.

In some embodiments, a central entity may, in its sole discretion, authorize certain third-party stakeholders to provide custodial, Issuance, Exchange, Reserve, or other services, and may outsource such services to such third parties.

In some embodiments, operational decisions as to how the assets are stored are determined by a central entity and any contractual/fiduciary responsibilities that exist with the token holder.

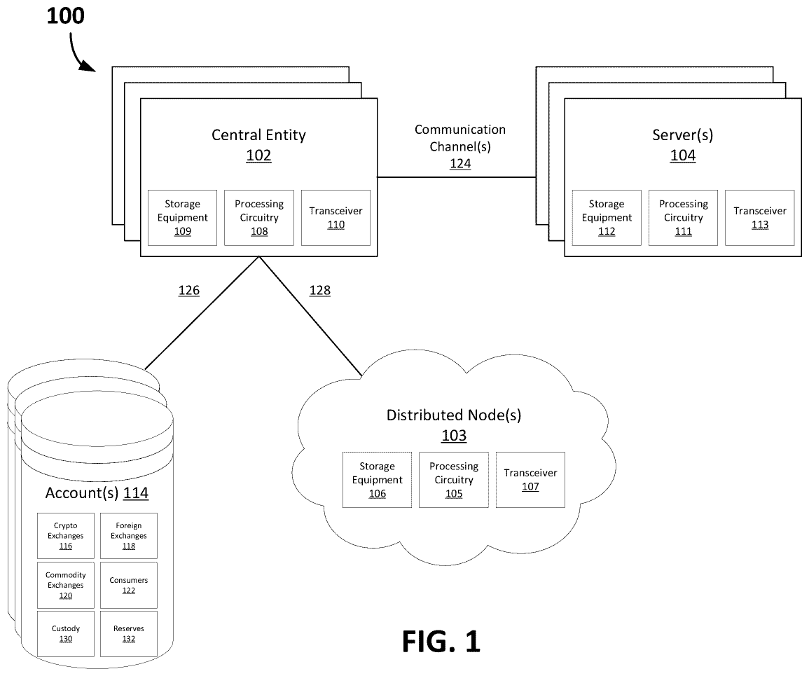

FIG. 1 shows an illustrative block diagram of a system 100 for providing a tokenized platform with reserve, in accordance with some embodiments of the disclosure. In one aspect, system 100 includes central entity 102, distributed node(s) 103, server(s) 104, account(s) 114, communication channel(s) 124, and system links 126 and 128. In particular, the central entity 102 may include processing circuitry 108 for calculating the value of the token. The central entity 102 may be controlled by any suitable one or more stakeholders. For example, the central entity may be controlled at least in part by an administrative entity as well as at least in part by one or more third-party stakeholders. The processing circuitry 108 may also update the value of the token and provide the value of the token to distributed node(s) 103 for use in a Transaction via system link 128. The processing circuitry 108 may also be for executing commands, performing operations, and otherwise processing information. The central entity 102 may include storage equipment 109 for storing respective quantities for a plurality of instruments. The storage equipment 109 (e.g. memory) may also be for storing information. The central entity 102 may include a transceiver 110 for receiving information about the plurality of instruments. The transceiver 110 may also receive updated information about the plurality of instruments. The transceiver 110 may receive information from a plurality of server(s) 104 over data communication channel(s) 124. The transceiver 110 may also be for transmitting and receiving signals, as well as linking to account(s) 114 via system link 126 and linking to distributed node(s) 103 via system link 128. In some embodiments, the central entity 102 may be a suitable part or a whole of devices located at either one location or at distributed locations, e.g., located at distributed node(s) 103 or located at one or more sites managed by one or more third-party stakeholders. In some embodiments, an instrument may be financial assets. Although FIG. 1 shows certain numbers of each component, in various examples, system 100 may include multiples of illustrated components.

In some embodiments, the server(s) 104 of system 100 include processing circuitry 111 for executing commands, performing operations, and otherwise processing information. The server(s) 104 may include storage equipment 112 (e.g. memory) for storing information. The server(s) 104 may include a transceiver 113 for transmitting and receiving signals, as well as linking to the central entity 102 via the communication channel(s) 124. In some embodiments, the server(s) 104 may be within the central entity 102. In some embodiments, the server(s) 104 may be managed and operated by the central entity 102.

In some embodiments, the distributed node(s) 103 include processing circuitry 105 for executing commands, performing operations, and otherwise processing information. The distributed node(s) 103 may include storage equipment 106 (e.g. memory) for storing information. The distributed node(s) 103 may include a transceiver 107 for transmitting and receiving signals, as well as linking to the central entity 102 via the system link 128.

In some embodiments, the account(s) 114 include crypto exchanges 116, foreign exchanges 118, and commodity exchanges 120. In some embodiments, these exchanges may provide real-time information, e.g., for dynamic token valuation, rebalancing, or modification. In some embodiments, some of these account(s) 114 may be under the custodianship of one or more third-party stakeholders. The account(s) 114 may also include consumers 122, custody 130, and Reserves 132. In some embodiments, these consumers 122 may buy tokens, e.g., via Issuance by the central entity 102. The consumers 122 may be individuals, institutions, or both, such as, for example, banks, funds, or businesses. In some embodiments, these consumers 122 may sell tokens, e.g., via Redemption by the central entity 102. Any account(s) 114 may initiate or request Transactions from central entity 102, which is configured to initiate a Transaction and to provide the value of the token to the distributed node(s) 103. The custody 130 may facilitate token Issuance, Redemption, or Exchange on behalf of token buyers and redeemers, e.g., consumers 122. The Reserves 132 may hold sufficient quantities of Underlying Assets to satisfy the Reserve Requirements of the token(s). The Reserves 132 may adjust in response to dynamic reevaluation of the Reserve Requirement by the central entity 102.

Through transceivers 110 and 107, the account(s) 114 are respectively linked to the central entity 102 via system link 128. In some embodiments, account(s) 114 may initiate or request Transactions from central entity 102. In some embodiments the central entity 102 stores a record of, and confirms, the Transactions. In some embodiments, central entity 102 may request information from server(s) 104 in connection with Transactions associated with tokens.

In some embodiments, network entities (e.g., a distributed node 103, server 104, central entity 102, or accounts 114) may be implemented using a multitenancy arrangement. For example, two distributed nodes may be associated with a particular computing equipment and node application but may process data in a partitioned and separate manner. In some embodiments, the multitenancy arrangement may include integration with third-party stakeholders and management of various network entities by such third-party stakeholders. These third-party stakeholders may host distributed node(s) 103, server(s) 104, account(s) 112, or any combination thereof. In implementation of such arrangements, the third-party stakeholders may automatically integrate with central entity 102 (or be a component thereof) and follow directives therefrom. In some embodiments, the third-party stakeholders may Exchange tokens using Exchange Rates provided by the central entity 102. Such Exchanges may occur through the central entity 102, or may occur directly between the third-party stakeholders. In some embodiments, certain tokens may be exclusive to a respective third-party stakeholder (i.e., third-party tokens) at the times of Issuance or Redemption, or through subsequent use in Transactions.

In some embodiments, network entities (e.g., a distributed node 103, server 104, or central entity 102) may be implemented using virtual machines. For example, distributed node(s) 103 and account(s) 112 or third-party stakeholders may be represented by network entities implemented using common computing equipment, each using a separate application implemented with respective virtual machines implemented in the computing equipment.

In some embodiments, system 100 implements a blockchain system, configured to store an immutable record among nodes. In some embodiments, the blockchain system includes the distributed node(s) 103.

In some embodiments, distributed node(s) 103 may initiate or request Transactions from central entity 102. In some embodiments, the central entity stores a record of, and confirms, the Transactions.

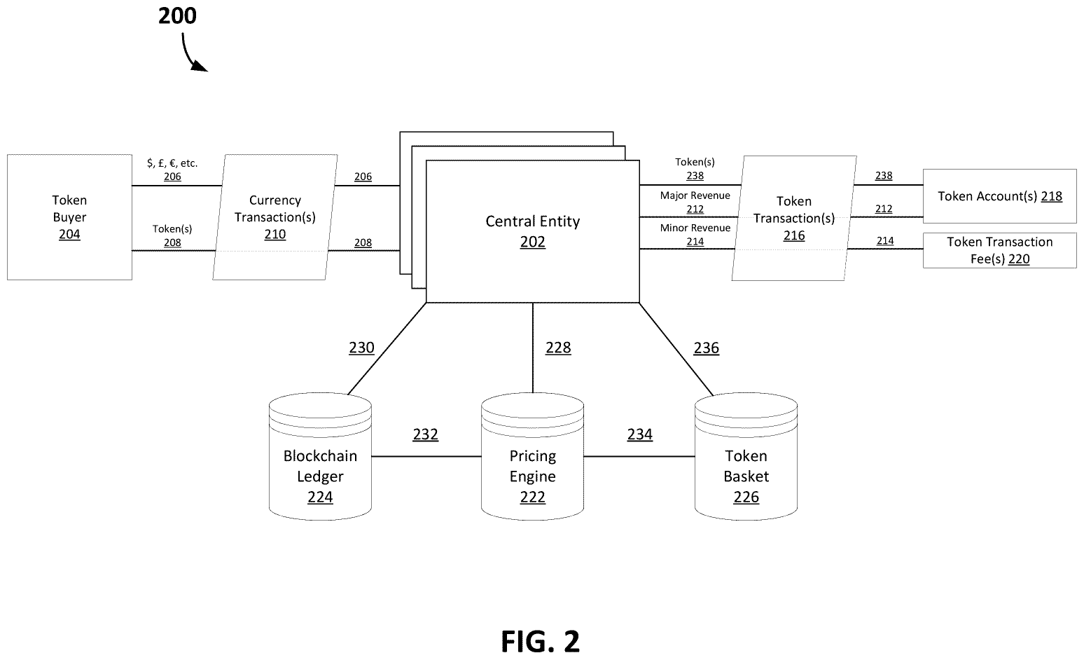

As shown in FIG. 2, a system 200 in which a central entity 202 operates includes executing transactions using computer-implemented systems, in accordance with some embodiments of the disclosure. In some embodiments, the central entity 202 is the central entity 102. In an example of system 200, a token buyer 204 executes currency Transaction(s) 210 with central entity 202, in which currency 206 (e.g., US Dollars, Gold, Silver, Euros, Norwegian Krona, Swiss Francs, Australian Dollars, Singapore Dollars, British Pounds, other global currencies, asset-backed cryptocurrencies, or commodities) and/or token(s) 208 are transacted through the central entity 202. The currency Transaction(s) 210 may include token Issuance or token Redemption. In response to the request for currency Transaction(s) 210, the central entity executes token Transaction(s) 216 with token account(s) 218. The token Transaction(s) include the Exchange of token(s) 238, which may be token(s) 208, and major revenue 212, which may be currency 206, through token account(s) 218. Token buyer 204 and token account(s) 218 may be one or more of the account(s) 114. In addition to the token and currency Transaction(s), the central entity 202 may process token Transaction fee(s) 220, which includes minor revenue 214, which is less than major revenue 212.

In some embodiments, the system 200 includes a computer-implemented pricing engine 222. The pricing engine is used by the central entity 202 to execute transactions via system link 228. In some embodiments, the pricing engine is included within the central entity. The pricing engine 222 may determine Unique Token values (e.g., Denominated Total Consideration, Denominated Quoted Token Value, Denominated Token Value/Price) based on information including, but not limited to, the Asset Mix, Underlying Asset(s), Asset Pair, Exchange Pair, Fees, Reserve Requirement, and Reserve Percentage. The pricing engine 222 is linked to a blockchain ledger 224 and a token basket 226 via system links 232 and 234, respectively. The pricing engine may initiate or request Transactions from the blockchain ledger 224. The pricing engine may collect Unique Token information from the token basket 226. In some embodiments, the pricing engine may be implemented by processing circuitry 108 and storage equipment 109, or processing circuitry 111 and storage equipment 112.

In some embodiments, the system 200 includes a computer-implemented blockchain ledger 224. The blockchain ledger is used by the central entity 202 to execute Transactions via system link 230. In some embodiments, the blockchain ledger is included within the central entity and is responsible for the reconciliation functionality of the central entity, which may include reconciling ledgers or accounts of one or more third-party stakeholders. The blockchain ledger 224 may store a replication of Issuance of tokens. The blockchain ledger may be public or private. In some embodiments, the blockchain ledger 224 is the distributed node(s) 103. In response to receiving a request from the central entity to initiate a Transaction, the blockchain ledger 224 may be updated to reflect the Transaction, e.g., in response to currency transaction(s) 210 or token Transaction(s) 216.

In some embodiments, the system 200 includes a computer-implemented token basket 226. The token basket is used by the central entity 202 to execute Transactions via system link 236. In some embodiments, the token basket is included within the central entity. The token basket 226 may store information about Unique Token(s), including, but not limited to, the Asset Mix, Underlying Asset(s), Asset Pair, Exchange Pair, Reserve Requirement, and Reserve Percentage. The token basket may dynamically receive real-time information relevant to the features of a Unique Token (e.g., Denominated Total Consideration, Denominated Quoted Token Value, Denominated Token Value/Price) and be updated accordingly. In some embodiments, the token basket may be implemented by processing circuitry 108 and storage equipment 109, or processing circuitry 111 and storage equipment 112. In some embodiments, the underlying Reserve of a token basket may be updated and maintained by a third-party stakeholder.

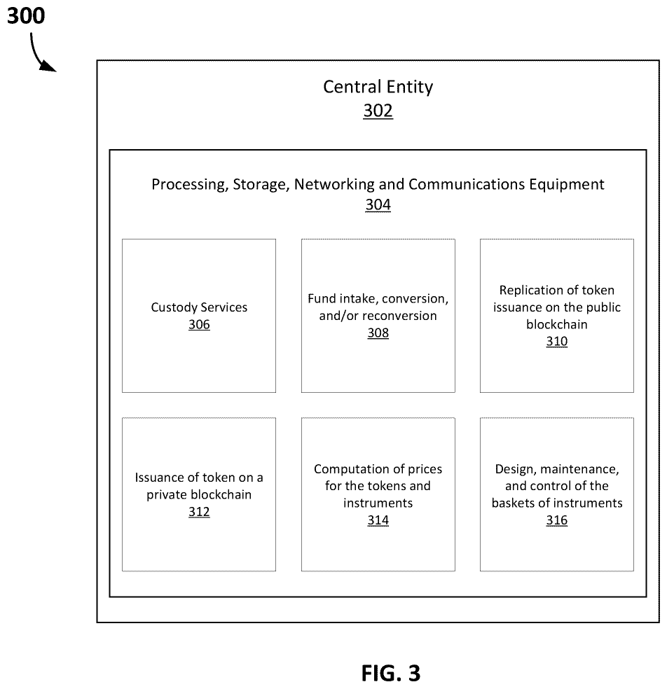

As shown in FIG. 3, a system 300 includes a central entity 302, the central entity including processing, storage, networking and communications equipment 304, in accordance with some embodiments of the disclosure. The central entity 302 may be central entity 202 or central entity 102.

The processing, storage, networking and communications equipment 304 performs functions including custody services 306. Custody services 306 may include execution of transactions, e.g., currency transaction(s) 210 or token transaction(s) 216, on behalf of account(s) 114, including consumers 122, or on behalf of token buyer 204 or token account(s) 218. Custody services 306 may also include updating the blockchain ledger 224, distributed node(s) 103, or other accounting of Transactions, in response to receiving a request to initiate a Transaction.

The processing, storage, networking and communications equipment 304 performs additional functions including fund intake, conversion, and/or reconversion 308. Fund intake, conversion, and/or reconversion may represent a step in the execution of Transactions, e.g., currency Transaction(s) 210 or token Transaction(s) 216, on behalf of account(s) 114, including consumers 122, or on behalf of token buyer 204 or token account(s) 218. Fund intake, conversion, and/or reconversion may also include the handling of currencies 206, token(s) 208, major revenue 212, minor revenue 214, token(s) 238, and token Transaction fee(s) 220.

The processing, storage, networking and communications equipment 304 performs additional functions including replication of token Issuance on the public blockchain 310 and/or Issuance of token on a private blockchain 312. These functions may represent one or more steps in the execution of Transactions, e.g., currency Transaction(s) 210 or token Transaction(s) 216, on behalf of account(s) 114, including consumers 122, or on behalf of token buyer 204 or token account(s) 218. These functions 310 and 312 may include updating the blockchain ledger 224, distributed node(s) 103, or other accounting of Transactions, in response to receiving a request to initiate a Transaction.

The processing, storage, networking and communications equipment 304 performs additional functions including computation of prices for the tokens and instruments 314. In some embodiments, the pricing engine 222 executes the computation of prices for the tokens and instruments. The computation of prices for the tokens and instruments may determine values a Unique Token (e.g., Denominated Total Consideration, Denominated Quoted Token Value, Denominated Token Value/Price) based on information including, but not limited to, the Asset Mix, Underlying Asset(s), Asset Pair, Exchange Pair, Fees, Reserve Requirement, and Reserve Percentage. This function 314 may include the valuation of token(s) 208 and token(s) 238. In some embodiments, the function 314 automatically updates the prices for the tokens and instruments in response to updated information received about these aspects or features thereof.

The processing, storage, networking and communications equipment 304 performs additional functions including design, maintenance, and control of the baskets of instruments 316. These functions may include determining, rebalancing, or modifying the Asset Mix, Underlying Asset(s), Asset Pair, Exchange Pair, Fees, Reserve Requirement, and/or Reserve Percentage of Unique Token(s). In some embodiments, the functions 316 automatically update the basket of instruments in response to updated information received about the instruments or features thereof.

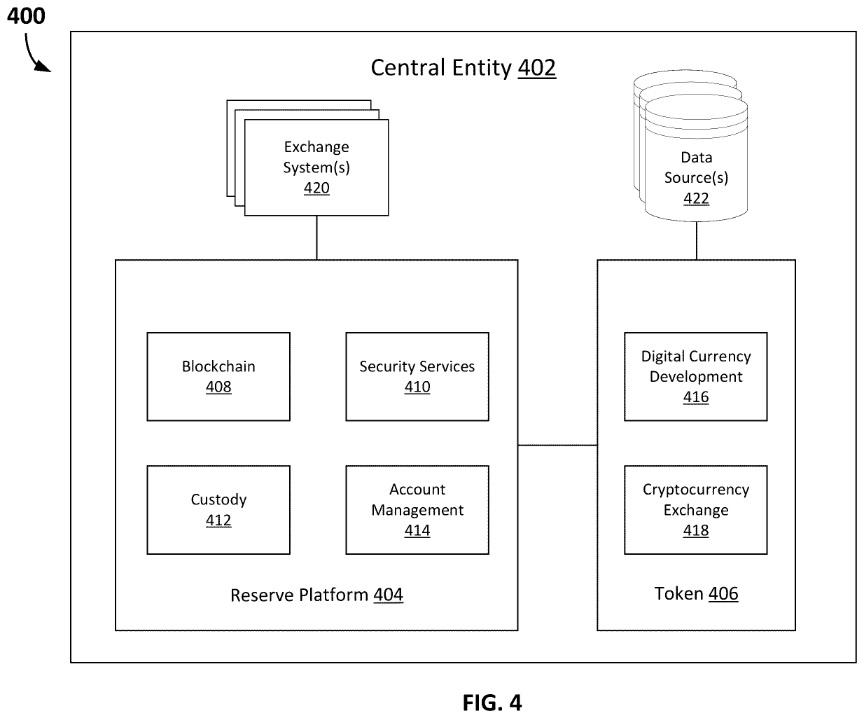

As shown in FIG. 4, a system 400 includes a central entity 402, the central entity including Reserve platform 404, token 406, exchange system(s) 420, and data source(s) 422, in accordance with some embodiments of the disclosure. The central entity 402 may be central entity 302, central entity 202, or central entity 102.

The Reserve platform 404 includes a blockchain 408, security services 410, custody 412, and account management 414. The blockchain 408 may be blockchain ledger 224 or distributed node(s) 103. The security services 410 may include the holding of currency 206, token(s) 208, major revenue 212, minor revenue 214, and/or token(s) 238. In some embodiments, the security services 410 are implemented in storage equipment 106, storage equipment 109, or storage equipment 112. The custody 412 may be custody services 306. Custody 412 may include execution of Transactions, e.g., currency Transaction(s) 210 or token Transaction(s) 216, on behalf of account(s) 114, including consumers 122, or on behalf of token buyer 204 or token account(s) 218. Custody 412 may also include updating the blockchain 408, blockchain ledger 224, distributed node(s) 103, or other accounting of Transactions, in response to receiving a request to initiate a Transaction. Account management 414 may include fund intake, conversion, and/or reconversion 308. Account management may also include reporting token ownership and dynamic token value on behalf of token buyer 204, consumers 122, or other stakeholders transacting with the central entity 402. The Reserve platform 404 executes one or more of these operations through exchange system(s) 420.

The token 406 includes digital currency development 416 and a cryptocurrency exchange 418. The digital currency development 416 may include determining, rebalancing, or modifying the Asset Mix, Underlying Asset(s), Asset Pair, Exchange Pair, Fees, Reserve Requirement, and/or Reserve Percentage of Unique Token(s). The cryptocurrency exchange 418 may be crypto exchanges 116 or other markets for the Issuance and Redemption of tokens, coins, currencies, or other financial instruments. The token 406 uses data source(s) 422 to receive dynamic information about features of the Unique Token (e.g., to update digital currency development 416) and about the cryptocurrency exchange 418.

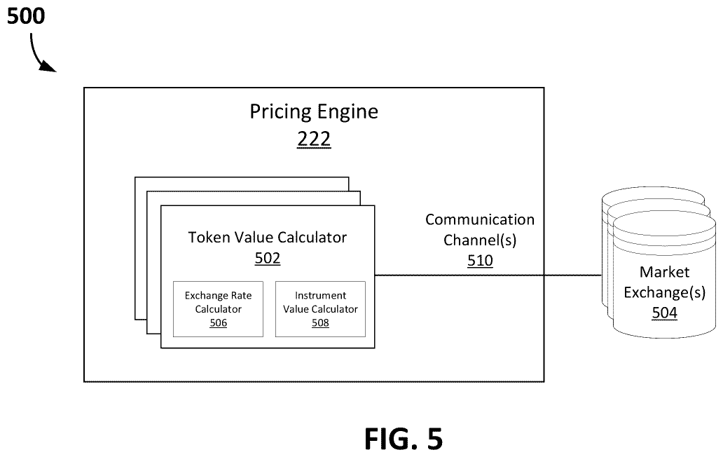

As explained above and also described here, FIG. 5 shows a system 500 including pricing engine 222, which includes token value calculator 502, and market exchange(s) 504, in accordance with some embodiments of the disclosure. Specific to each Unique Token, the token value calculator includes an exchange rate calculator 506 and an instrument value calculator 508. The exchange rate calculator includes information about the Underlying Asset values, e.g., real-time unit pricing. The token value calculator 502 calculates the value of a token based on the features of the token including the Denominated Total Consideration, Denominated Quoted Asset, Denominated Token Price, and Denominated Quoted Token Value, based on the Underlying Asset values and the Asset Mix. Through communication channel(s) 510, the token value calculator 502 receives information from market exchange(s) 504 to inform the calculations thereof. In some embodiments, the token value calculator receives the market exchange(s) information in real-time and automatically updates the token values.

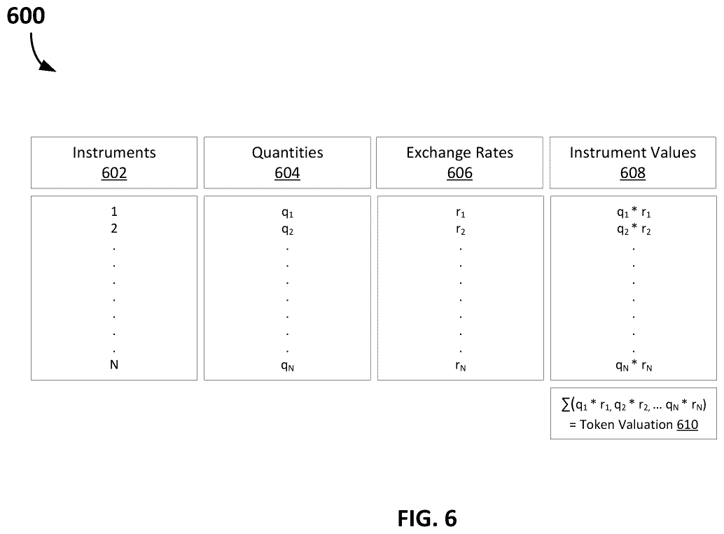

As shown in FIG. 6, a method 600 for token valuation 612 includes consideration of underlying instruments 602, quantities 604, exchange rates 606, and instrument values 608. The instruments 602 may include currencies 206 or other asset-backed commodities or financial instruments, e.g., asset-backed cryptocurrencies, precious metals, fuels, physical assets, other commodities, or other instruments actively traded on public market exchanges, in accordance with some embodiments of the disclosure. One instrument may be one Underlying Asset of the Unique Token. Each respective instrument of the instruments 602 is assigned a respective quantity from the quantities 604. Each respective quantity for each respective instrument may be reported as the number of units of that respective instrument that is held in the Asset Mix underlying the token. Each respective instrument of the instruments 602 is also assigned an exchange rate from the exchange rates 606. Each exchange rate for each respective instrument may be reported as a unit value of the instrument with respect to the Base Asset. For example, considering the US Dollar as the Base Asset and gold as the Underlying Asset, the exchange rate of gold may correspond to the market exchange rate of gold expressed as US Dollar per ounce of gold. This market exchange rate may be determined from account(s) 114, data source(s) 422, market exchange(s) 504, or comparable real-time markets trading the relevant Underlying Asset. Thus, respective instrument values 608 for each respective instrument are determined by multiplying the respective instrument quantity 604 with the respective instrument exchange rate 606. Finally, token valuation 610 is determined by summing the respective instrument values for each respective instrument.

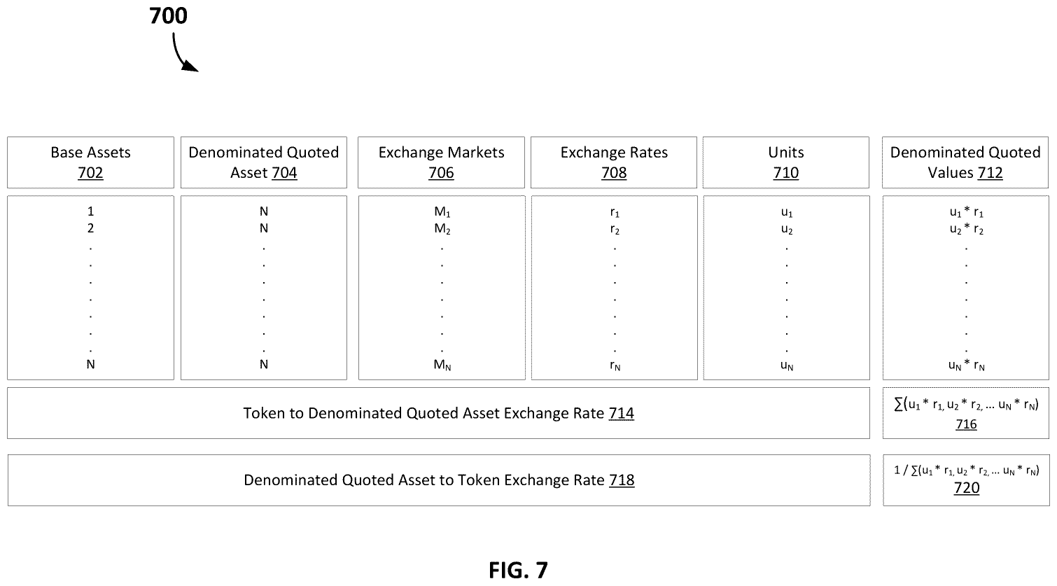

As shown in FIG. 7, a method 700 for determining token exchange rates (i.e., Token to Denominated Quoted Asset Exchange Rate 714 and Denominated Quoted Asset to Token Exchange Rate 718) includes consideration of Base Assets 702, Denominated Quoted Asset 704, exchange markets 706, exchange rates 708, units 710, and Denominated Quoted Values 712, in accordance with some embodiments of the disclosure. In some embodiments, the Base Assets 702 may be the instruments 602. For a given Base Asset of Base Assets 702, the respective Denominated Quoted Value is equal to the product of the respective units and respective exchange rate of the given Base Asset. The token to Denominated Quoted Asset exchange rate 714 is equal to the summation 716 of the Denominated Quoted Values 712. The Denominated Quoted Asset to token exchange rate 718 is equal to the reciprocal 720 of the summation 716.

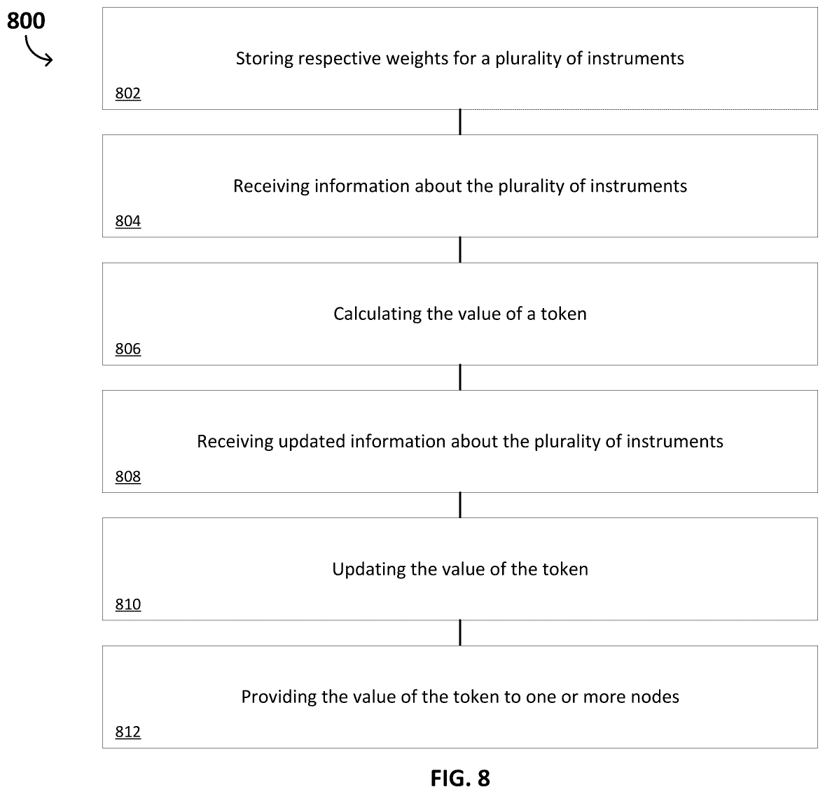

FIG. 8 is a flowchart 800 of a process for providing a tokenized platform with reserve, in accordance with some embodiments of the disclosure. At 802, a central entity (i.e., 102, 202, 302, or 402) stores respective quantities for a plurality of instruments. The respective quantities may be stored in storage equipment 109 or 112, token basket 226, processing, storage, networking and communications equipment 304, data source(s) 422, or any combination thereof. Each of the plurality of instruments may compose a token, e.g., tokens 208, 238, or 406. The instruments of the plurality of instruments may be traded on crypto exchanges 116, foreign exchanges 118, commodity exchanges 120, market exchange(s) 504, or any combination thereof.

At 804, the central entity receives information about the plurality of instruments. The information may be received using transceivers 107, 110, or 113. The information may be received from distributed node(s) 103, account(s) 114, blockchain ledger 224, data source(s) 422, market exchange(s) 504, or any combination thereof. The information may be received from sources in different time zones. The information may include details of an Underlying Asset, e.g., price, trading volume, market capitalization, or other financial information. A central entity may automatically receive the information at predetermined intervals, and these intervals may be very short (e.g., less than one second).

At 806, the central entity calculates the value of a token. This value may be calculated using processing circuitry 108 or 111, pricing engine 222, processing, storage, networking and communications equipment 304, or any combination thereof. This value may be calculated using the methods 600 or 700, and may yield a token valuation 612, or an exchange rate 714 or 718. Token values may be calculated toward executing token Issuance, Redemption, Exchange, or any combination thereof. Token values may also be calculated toward establishing Reserve Requirements and/or Reserve Percentages. The token value may depend on the plurality of instruments, Underlying Assets, Asset Mix, and financial information pertaining to the plurality of instruments, Underlying Assets, or Asset Mix.

At 808, the central entity receives updated information about the plurality of instruments. The updated information may be received using transceivers 107, 110, or 113. The updated information may be received from distributed node(s) 103, account(s) 114, blockchain ledger 224, data source(s) 422, market exchange(s) 504, or any combination thereof. The updated information may be received from sources in different time zones. The updated information may include details of an Underlying Asset, e.g., price, trading volume, market capitalization, or other financial information. The central entity may automatically receive the updated information at predetermined intervals, and the intervals may be very short (e.g., less than one second).

At 810, the central entity updates the value of a token. This updated value may be calculated using processing circuitry 108 or 111, pricing engine 222, processing, storage, networking and communications equipment 304, or any combination thereof. This updated value may be calculated using the methods 600 or 700, and may yield a token valuation 612, or an exchange rate 714 or 718. Updated token values may be calculated toward executing token Issuance, Redemption, Exchange, or any combination thereof. Updated token values may also be calculated toward establishing Reserve Requirements and/or Reserve Percentages. The updated token value may depend on the plurality of instruments, Underlying Assets, Asset Mix, or financial information thereof. Upon receiving updated information 808, the central entity may automatically update a calculated token value 806 to an updated token value.

At 812, the central entity provides a value of the token to one or more nodes. This process may include providing the value to distributed node(s) 103, blockchain ledger 224, blockchain 408, or cryptocurrency exchanges 116 or 418 using transceiver 107, 110, or 113. This process may also include providing the value via replication of token Issuance on the public blockchain 310 or Issuance of token on a private blockchain 312 using the processing, storage, networking, and communications equipment 304. Providing a value of the token to one or more nodes may result in or enable the execution of token Issuance, Redemption, Exchange, or any combination thereof.

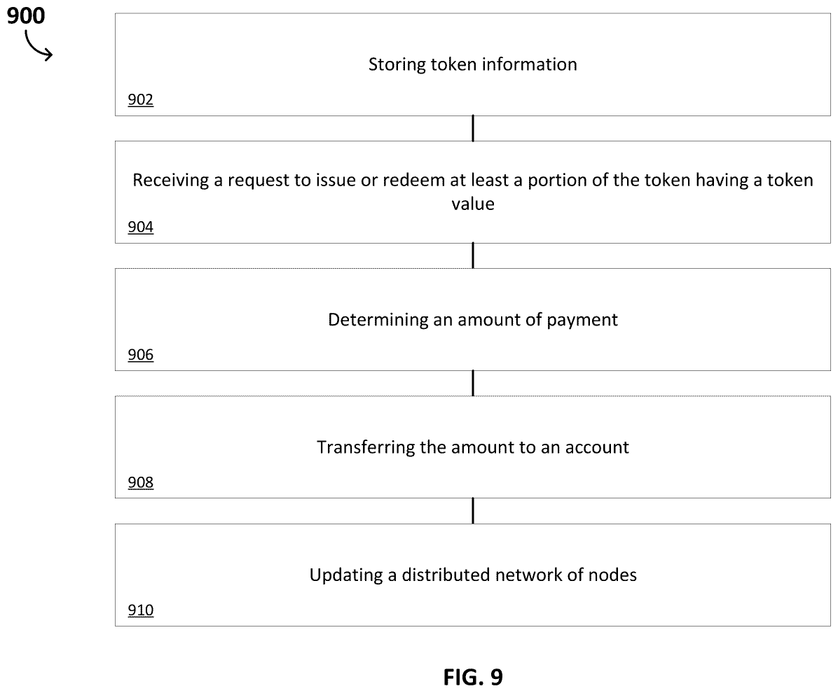

FIG. 9 is a flowchart 900 of another process for providing a tokenized platform with reserve, in accordance with some embodiments of the disclosure. At 902, a central entity (i.e., 102, 202, 302, or 402) stores token information, e.g., token 208, 238, or 406, or token basket 226. The token information may include a plurality of Unique Tokens. The token information may be stored in storage equipment 109 or 112, token basket 226, processing, storage, networking and communications equipment 304, data source(s) 422, or any combination thereof. The token information may include a plurality of instruments, Underlying Assets, Asset Mix, Reserve Requirement, Reserve Percentage, or any combination thereof. The token information may be made available to distributed node(s) 103, account(s) 114, token buyer 204, token account(s) 218, blockchain ledger 224, blockchain 408, cryptocurrency exchange 418, market exchanges(s) 504, or any combination thereof. The information may be available to third parties persistently, or it may be made available upon request.

At 904, the central entity receives a request to issue or redeem at least a portion of the token having a token value. The request may be received through transceivers 107, 110, 113, or any combination thereof, or through processing, storage, networking and communications equipment 304 or exchange system(s) 420. The request may generate from distributed node(s) 103, account(s) 114, token buyer 204, token account(s) 218, blockchain ledger 224, blockchain 408, cryptocurrency exchange 418, market exchanges(s) 504, or any combination thereof. Receiving the request may be an aspect of custody services 306 or custody 412.

At 906, the central entity determines an amount of payment. The determination of the amount of payment may be executed using processing circuitry 108 or 111, pricing engine 222, processing, storage, networking and communications equipment 304, or any combination thereof. The determination of the amount of payment may incorporate the token value, e.g., as determined at 806 or 810, e.g., using method 600 or 700, and it may also incorporate token Transaction fee(s) 220. In accordance with dynamically adjusted token values, the central entity may automatically determine the amount of payment in response to receiving the request 904. The amount of payment may be classified in terms of major revenue 212 and minor revenue 214, where the major revenue may correspond to token(s), e.g., 208, 238, or 406, and the minor revenue may correspond to Transaction fee(s) 220. The amount of payment may be stored, e.g., on storage equipment 109 or 112, until a time when the amount of payment is transferred, e.g., to execute Transactions.

At 908, the central entity transfers the amount to an account. The transferring of the amount to an account may be executed using transceivers 110 or 113, or processing, storage, networking and communications equipment 304. The account may be account(s) 114 token buyer 204, token account(s) 218, or any combination thereof, or the account may be integrated with blockchain ledger 224, blockchain 408, cryptocurrency exchange 418, market exchanges(s) 504, or any combination thereof. The transferring of the amount may be executed as per Issuance, Redemption, or Exchange of the token. The transferring of the amount may be an aspect of currency Transaction(s) 210, token Transaction(s) 216, custody services 306, fund intake conversion, and/or reconversion 308, custody 412, account management 414, exchange system(s) 420, or any combination thereof.

At 910, the central entity updates a distributed network of nodes. The update may be executed using transceivers 110 or 113, or processing, storage, networking and communications equipment 304. The distributed network of nodes may be distributed node(s) 103, crypto exchanges 116, blockchain ledger 224, blockchain 408, cryptocurrency exchange 418, or any combination thereof. The update may include replication of token Issuance on the public blockchain 310, or Issuance of token on a private blockchain 312. The distributed network of nodes may be updated to store a record of a Transaction involving a token, e.g., token Transaction 216, and the record may be stored using storage equipment 106.

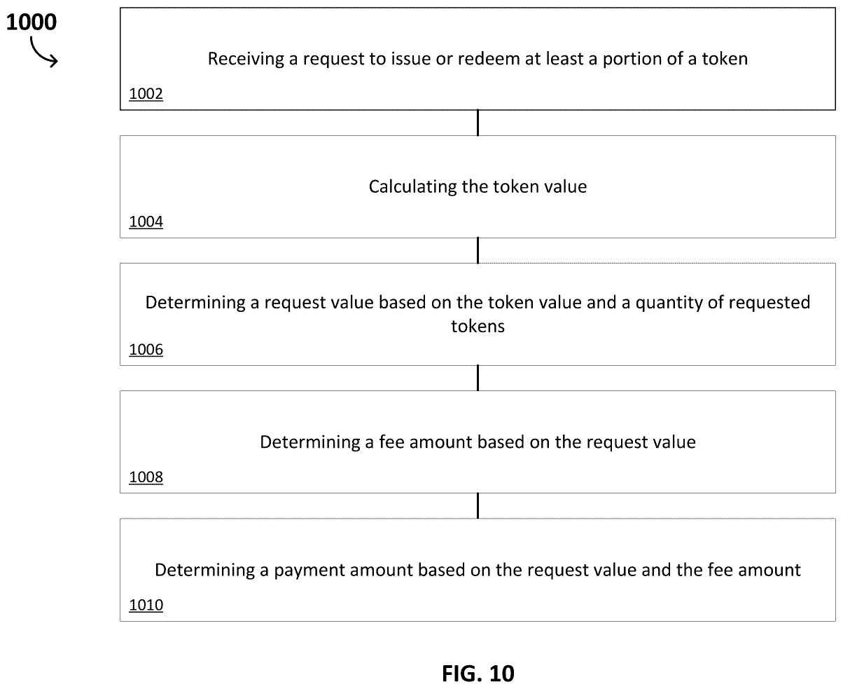

FIG. 10 is a flowchart 1000 of a process for handling a token issuance or redemption request, in accordance with some embodiments of the disclosure. At 1002, a central entity (i.e., 102, 202, 302, or 402) receives a request to issue or redeem at least a portion of a token. This request may be request 904. The request may be received through transceivers 107, 110, 113, or any combination thereof, or through processing, storage, networking and communications equipment 304 or exchange system(s) 420. The request may generate from distributed node(s) 103, account(s) 114, token buyer 204, token account(s) 218, blockchain ledger 224, blockchain 408, cryptocurrency exchange 418, market exchanges(s) 504, or any combination thereof. Receiving the request may be an aspect of custody services 306 or custody 412.

At 1004, the central entity calculates the token value. This calculation may be the calculation step 806 or update step 810. The value may be calculated using processing circuitry 108 or 111, pricing engine 222, processing, storage, networking and communications equipment 304, or any combination thereof. The value may be calculated using the methods 600 or 700, and may yield a token valuation 612, or an exchange rate 714 or 718. Token values may be calculated toward executing Issuance, Redemption, Exchange, or any combination thereof. Token values may also be calculated toward establishing Reserve Requirements and/or Reserve Percentages. The token value may depend on the plurality of instruments, Underlying Assets, Asset Mix, and financial information pertaining to the plurality of instruments, Underlying Assets, or Asset Mix.

At 1006, the central entity determines a request value based on the token value and a quantity of requested tokens. The request value may be equal to a product of the token value and the quantity of requested tokens. The value may be calculated using processing circuitry 108 or 111, pricing engine 222, processing, storage, networking and communications equipment 304, or any combination thereof. The value may be calculated using the methods 600 or 700 and may yield an exchange rate 714 or 718.

At 1008, the central entity determines a fee amount based on the request value. The fee amount may correspond to the token value, the quantity of requested tokens, the product of the token value and the quantity of requested tokens, or other factors related to the Transaction. The fee amount may be calculated using processing circuitry 108 or 111, pricing engine 222, processing, storage, networking and communications equipment 304, or any combination thereof. The fee amount may be the minor revenue 214 and/or token Transaction fee(s) 220. In some embodiments, the fee amount may be zero. Nonzero fee amounts may support operations of the central entity, e.g., as depicted in 100, 200, 300, 400, or any combination thereof.

At 1010, the central entity determines a payment amount based on the request value and the fee amount. The payment amount may be the sum of the request value and the fee amount. The payment amount may be calculated using processing circuitry 108 or 111, pricing engine 222, processing, storage, networking and communications equipment 304, or any combination thereof. The determining a payment amount may be the determinations step 906.

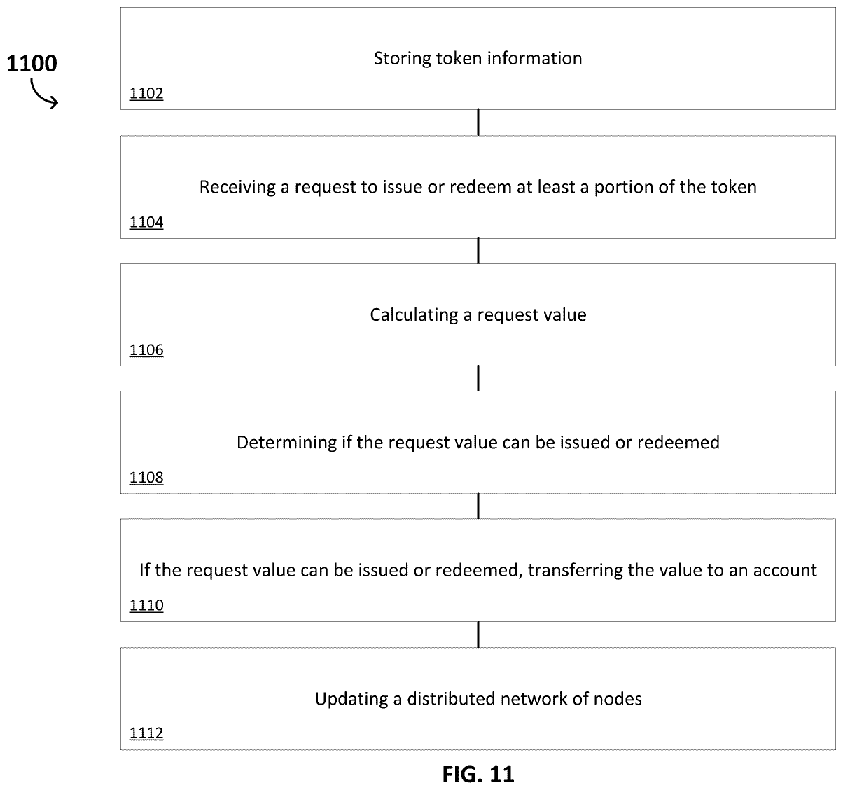

FIG. 11 is a flowchart 1100 of another process for handling a token issuance or redemption request, in accordance with some embodiments of the disclosure. At 1102, a central entity (i.e., 102, 202, 302, or 402) stores token information, e.g., token 208, 238, or 406, or token basket 226. The storing token information may be the storing step 902. The token information may include a plurality of Unique Tokens. The token information may be stored in storage equipment 109 or 112, token basket 226, processing, storage, networking and communications equipment 304, data source(s) 422, or any combination thereof.

At 1104, the central entity receives a request to issue or redeem at least a portion of the token. The receiving the request may be the receiving step 904 or 1002. The request may be received through transceivers 107, 110, 113, or any combination thereof, or through processing, storage, networking and communications equipment 304 or exchange system(s) 420. The request may generate from distributed node(s) 103, account(s) 114, token buyer 204, token account(s) 218, blockchain ledger 224, blockchain 408, cryptocurrency exchange 418, market exchanges(s) 504, or any combination thereof.

At 1106, the central entity calculates a request value. The calculation may be calculation step 1006. The request value may be equal to a product of the token value and the quantity of requested tokens. The value may be calculated using processing circuitry 108 or 111, pricing engine 222, processing, storage, networking and communications equipment 304, or any combination thereof. The value may be calculated using the methods 600 or 700 and may yield an exchange rate 714 or 718.

At 1108, the central entity determines if the request value can be issued or redeemed. The determination may be executed using processing circuitry 108 or 111 in conjunction with storage equipment 109 or 112. The determination may depend on values of account(s) 114, and it may be executed using transceiver 110 and system link 126. The determination may be made upon consideration of tokens, funds, or other financial instruments held by the token buyer 204 and the token account(s) 218. The determination may be made upon request from distributed node(s) 103, account(s) 114, token buyer 204, token account(s) 218, blockchain ledger 224, blockchain 408, cryptocurrency exchange 418, market exchanges(s) 504, or any combination thereof. The determination may result in a decision wherein the request value can, or cannot, be issued or redeemed.

At 1110, if the request value can be issued or redeemed, the central entity transfers the value to an account. The transferring the value may be the transferring step 908. The transferring of the amount to an account may be executed using transceivers 110 or 113, or processing, storage, networking and communications equipment 304. The account may be account(s) 114 token buyer 204, token account(s) 218, or any combination thereof, or the account may be integrated with blockchain ledger 224, blockchain 408, cryptocurrency exchange 418, market exchanges(s) 504, or any combination thereof. The transferring of the amount may be executed as per Issuance or Redemption of the token. The transferring of the amount may be an aspect of currency Transaction(s) 210, token Transaction(s) 216, custody services 306, fund intake conversion, and/or reconversion 308, custody 412, account management 414, exchange system(s) 420, or any combination thereof.

At 1112, the central entity updates a distributed network of nodes. The update may be the update step 910. The update may be executed using transceivers 110 or 113, or processing, storage, networking and communications equipment 304. The distributed network of nodes may be distributed node(s) 103, crypto exchanges 116, blockchain ledger 224, blockchain 408, cryptocurrency exchange 418, or any combination thereof. The update may include replication of token Issuance or Redemption on the public blockchain 310 or token Issuance or Redemption on a private blockchain 312. The distributed network of nodes may be updated to store a record of a Transaction involving a token, e.g., token Transaction 216, and the record may be stored using storage equipment 106.

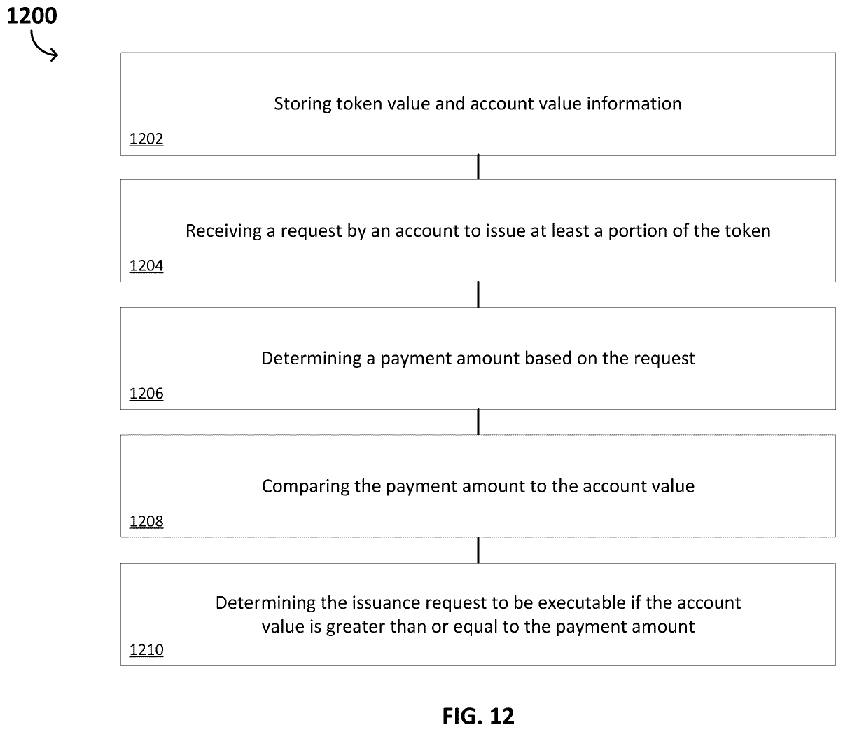

FIG. 12 is a flowchart 1200 of a process for determining the ability to execute a token issuance request, in accordance with some embodiments of the disclosure. At 1202, a central entity (i.e., 102, 202, 302, or 402), stores token value and account information. The token information may be the stored information of step 902 or step 1102. The token information may include a plurality of Unique Tokens. The token information may be stored in storage equipment 109 or 112, token basket 226, processing, storage, networking and communications equipment 304, data source(s) 422, or any combination thereof. The account information may be account(s) 114 token buyer 204, token account(s) 218, or any combination thereof, or the account may be integrated with blockchain ledger 224, blockchain 408, cryptocurrency exchange 418, market exchanges(s) 504, or any combination thereof. The account information may be stored in storage equipment 109 or 112, storage, networking and communications equipment 304, data source(s) 422, or any combination thereof.

At 1204, the central entity receives a request by an account to issue at least a portion of the token. The receiving the request may be receiving steps 904, 1002, or 1104. The request may be received through transceivers 107, 110, 113, or any combination thereof, or through processing, storage, networking and communications equipment 304 or exchange system(s) 420. The request may generate from distributed node(s) 103, account(s) 114, token buyer 204, token account(s) 218, blockchain ledger 224, blockchain 408, cryptocurrency exchange 418, market exchanges(s) 504, or any combination thereof.

At 1206, the central entity determines a payment amount based on the request. The determination may be the determination step 906. The determination of the amount of payment may be executed using proceeding circuitry 108 or 111, pricing engine 222, processing, storage, networking and communications equipment 304, or any combination thereof. The determination of the amount of payment may incorporate the token value, e.g., as determined at steps 806 or 810, e.g., using method 600 or 700, and it may also incorporate token Transaction fee(s) 220.

At 1208, the central entity compares the payment amount to the account value. The comparison may step 1108. The comparison may be executed using processing circuitry 108 or 111 in conjunction with storage equipment 109 or 112. The comparison may depend on values of the token and the account.

At 1210, the central entity determines the issuance request to be executable if the account value is greater than or equal to the payment amount. The determination may be the determination step 1110. The payment amount may be inclusive or exclusive of Transaction fee(s) 220. The determination may be executed using processing circuitry 108 or 111 in conjunction with storage equipment 109 or 112.

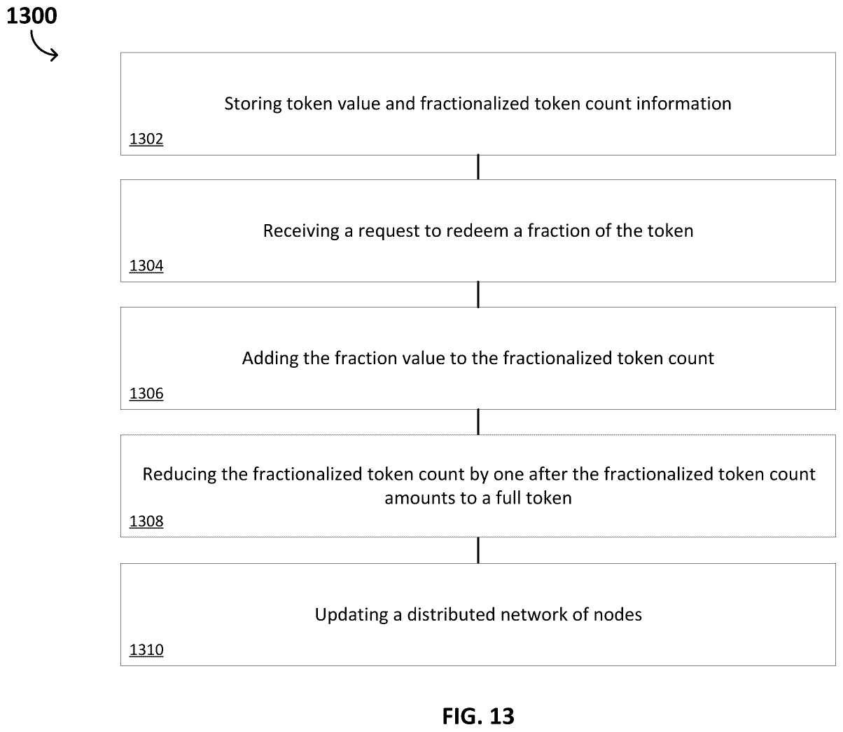

FIG. 13 is a flowchart 1300 of a process for redemption of a fractional token, in accordance with some embodiments of the disclosure. At 1302, a central entity (i.e., 102, 202, 302, or 402), stores token value and fractionalized token count information. At 1304, the central entity receives a request by an account to redeem a fraction of the token. At 1306, the central entity adds the fraction value to the fractionalized token count. In some embodiments, this fractionalized token count may be stored on storage equipment 106, 109, or 112, blockchain ledger 224, processing, storage, network and communications equipment 304, or blockchain 408. At 1308, the central entity reduces the fractionalized token count by one after the fractionalized token count amounts to a full token. In some embodiments, the central entity increases a related token count by one. At 1310, the central entity updates a distributed network of nodes (e.g., distributed node(s) 103, blockchain ledger 224, or blockchain 408).

In accordance with the aforementioned drawings and some embodiments of the present disclosure, the following examples illustrate aspects of the disclosure.

The following examples are illustrative of custody services 306, custody 412, or similar functions performed by at least one central entity 102, 202, 302, or 402 and possibly in coordination with at least one third-party stakeholder. These examples assume the use of a relational database table to maintain the required information for 3 Unique Tokens. The table tbl_TokenConfiguration has one entry per Unique Token. Each entry in the table must, at a minimum, contain the fields shown, and creates relationships for the indicated Unique Token referencing:
1. tbl_AssetMixDetails, using the key AssetMixID, to find the Unique Token's current Asset Mix; and
2. ReserveTerms, using the key AssetMixID, to obtain the Unique Token's current Reserve Requirement

tbl_TokenConfiguration

| TokenID | TokenName | Symbol | AssetMixID | ICODate | ReserveTermsID |
|---|---|---|---|---|---|
| 1 | Sovereign | SOV | 100 | Jan. 1, 2021 | GUID |
| 2 | Crown | CRN | 102 | Jun. 15, 2021 | GUID |
| 3 | Numi | NUM | 101 | Jun. 15, 2021 | GUID |

ReserveTermsID values correspond to files that contain the requirements and restrictions regarding any Reserve that might be held as collateral against Issuances of Unique Tokens. These values will include the Reserve Requirement and will be dynamically communicated to the Reserve holder (e.g., the central entity and/or a third-party stakeholder).

The table tbl_AssetType contains a unique record for each type of asset (USD, EUR, GOLD, etc.) that may be used in the system. Asset types must exist in the table before they can be included in the Asset Mix of any Unique Token. Asset types cannot be removed from this table once added. The same exact list of asset types may apply to more than one Unique Token.

tbl_AssetType

| AssetTypeID | AssetName | AssetSymbol |
|---|---|---|
| 50 | US Dollar | USD |
| 51 | Euro | EUR |
| 52 | Gold Oz. | AUG |

The following examples are illustrative of token account(s) 218, token basket 226, design, maintenance, and control of the baskets of instruments 316, token 406, or similar functions performed by at least one central entity 102, 202, 302, or 402. These examples assume the use of a relational database table to maintain the required information for Underlying Assets, Asset Pairs, and Exchange Pairs.

The table tbl_AssetMiaDetail contains details regarding all asset types, and the number of units of all such asset types, that are associated with a Unique Token.

Tbl_AssetMixDetail

| AssetMixDetailID | AssetMixID | AssetTypeID | Unit Quantity |
|---|---|---|---|
| 50 | 100 | 50 | 10.0000 |
| 51 | 101 | 50 | 20.0000 |
| 52 | 100 | 51 | 8.0000 |
| 53 | 101 | 51 | 4.0000 |
| 54 | 100 | 52 | 0.0100 |
| 55 | 101 | 52 | 0.0100 |
| 56 | 102 | 52 | 1.0000 |
| 57 | 102 | 51 | 400.00 |

The Asset Mix for each Unique Token can be determined by joining the data from the above 3 tables and filtering the results to the AssetMixID associated with the Unique Token.

Query Results for AssetMix 100

| | | | | Unit |
|---|---|---|---|---|
| AssetMixID | AssetTypeID | Asset Name | Asset Symbol | Quantity |
| 100 | 50 | US Dollar | USD | 10 |
| 100 | 51 | Euro | EUR | 8 |
| 100 | 52 | Gold | XAU | 0.01 |

In some embodiments, the below tables and charts illustrate the process with respect to an exemplary Unique Token, referred to as the Numi. The Numi (TokenID 3) is associated with AssetMixID 101 which results in the Asset Mix shown below.

Query Results for AssetMix 101

| | | | | Unit |
|---|---|---|---|---|
| AssetMixID | AssetTypeID | Asset Name | Asset Symbol | Quantity |
| 101 | 50 | US Dollar | USD | 20.0000 |
| 101 | 51 | Euro | EUR | 4.0000 |
| 101 | 52 | Gold | XAU | 0.0100 |

The data from tbl_AssetType may be used to generate Asset Pairs.

Asset Pairs (Non-Ordered)

| Asset Pair Item | Asset Pair Item |
|---|---|
| USD | EUR |
| USD | XAU |
| EUR | XAU |

The Asset Pairs may be used to generate Exchange Pairs

Exchange Pairs

| Base Asset | Denominated Quoted Asset |
|---|---|
| USD | EUR |
| USD | XAU |
| EUR | USD |
| EUR | XAU |
| XAU | USD |
| XAU | EUR |

The following examples are illustrative of account(s) 114 (e.g., crypto exchanges 116, foreign exchanges 118, or commodity exchanges 120), data source(s) 422, or similar systems linked to at least one central entity 102, 202, 302, or 402. These examples use a relational database table to maintain the required information for Underlying Assets.

The table tbl_EchangeMarkets contains information regarding the global exchanges for the assets in the tbl_AssetType. Additional data regarding the market hours will be stored using Greenwich Mean Time (GMT).

tbl_ExchangeMarkets

| ExchangeID | Market Exchange Name | Market Information |
|---|---|---|
| 8001 | Chicago | <market information> |
| 8002 | Tokyo | <market information> |
| 8003 | London | <market information> |
| 8004 | Germany | <market information> |

Feeds from each Market Exchange that is open at any given time will be paired with the Asset Pairs where the Base Asset and Denominated Quoted Asset are not the same. For example, at 1 PM GMT, the Market Exchanges in Germany and Tokyo are open. The pricing engine 222 establishes real-time trade prices for all Exchange Pairs from those two exchanges.

All Available Market Exchange Rates

| | | Denominated | |
|---|---|---|---|
| Exchange | Base Asset | Quoted Asset | Exchange Rate |
| Germany | USD | EUR | exchange_rate |
| Germany | USD | XAU | exchange_rate |
| Germany | EUR | USD | exchange_rate |
| Germany | EUR | XAU | exchange_rate |
| Germany | XAU | USD | exchange_rate |
| Germany | XAU | EUR | exchange_rate |
| Tokyo | USD | EUR | exchange_rate |
| Tokyo | USD | XAU | exchange_rate |
| Tokyo | EUR | USD | exchange_rate |
| Tokyo | EUR | XAU | exchange_rate |
| Tokyo | XAU | USD | exchange_rate |
| Tokyo | XAU | EUR | exchange_rate |

The data is then flattened to represent the best market rates, and generic records are added for every asset where the Base Asset and Denominated Quoted Asset are equal with a rate of 1.

Best Exchange Rate

| | | Exchnage | |
|---|---|---|---|
| BaseAsset | DenominatedQuotedAsset | Market | Exchange Rate |
| USD | EUR | Germany | exchange_rate |
| USD | XAU | Germany | exchange_rate |
| EUR | USD | Germany | exchange_rate |
| EUR | XAU | Tokyo | exchange_rate |
| XAU | USD | Tokyo | exchange_rate |
| XAU | EUR | Tokyo | exchange_rate |
| USD | USD | Global | 1 |
| EUR | EUR | Global | 1 |
| XAU | XAU | Global | 1 |

The following shows an exchange rate calculation method, e.g., as described in method 600 or 700. The exchange rate to value ratio for any unique asset type in an Asset Mix expressed in denominated units of another unique asset type in the same Asset Mix can be calculated using the data above by (1) pricing out the Denominated Quoted Asset in the Asset Mix, in denominated units of the Base Asset, and (2) dividing 1.000 by the total cost determined in (1) above.

For example, pricing the token in Euros would use feed data from the middle rows of the previous table.

Example of Numi (TokenID 3) being priced
with EUR as the Denominated Quoted Asset

| | Denominated | Exchange | | | Denominated |
|---|---|---|---|---|---|
| Base Asset | Quoted Asset | Market | Exchange Rate | Units | QuotedValue |
| USD | EUR | Germany | 0.88466 | 20.0000 | 17.69320 |
| XAU | EUR | Tokyo | 1599.45182 | 0.0100 | 15.99451 |
| EUR | EUR | Global | 1.00000 | 4.0000 | 4.00000 |

| | |
|---|---|
| NUM to EUR Exchange Rate | 37.68771 |
| EUR to NUM Exchange Rate (1.000/37.68771) | 0.02653385 |

In some embodiments, the system allows unlimited divisibility. In some embodiments, the central entity may limit the Redemptions to a specific fraction such as because some of the assets in the basket are only divisible to certain decimals. The system can receive a desired quantity for conversion and return both the converted amount and a remainder.

In some embodiments, the system is a ledger-based system for distributing, redeeming and reissuing tokens that represent a fractionalized ownership of tangible and intangible assets held by the central entity. In some embodiments, the central entity may act as the custodian of an asset using a computer-implemented model to generate and distribute tokens representing a fractional interest in the custodial asset. In some embodiments, the computer-implemented method executed by the central entity may direct corresponding activity as executed by third-party stakeholders.

In some embodiments, the system maintains information regarding the asset and all associated tokens representing an accounting of all (outstanding) fractional interest in the asset.

In some embodiments, tokens can represent varying ownership of the same Underlying Asset and can be further (1) subdivided by the central entity into two or more tokens representing a distribution of the divided tokens interest and (2) can consolidate two or more tokens for the same asset into a single token representing the sum of the combined tokens.

In some embodiments, the system embodies the ability for the central entity to redeem outstanding tokens, in whole or in part, in Exchange for custodial assets that are not encumbered by an outstanding token. Such Redemptions are calculated using computer aided pricing data which represents the market value of the fractional interest represented by the token.

In some embodiments, each Unique Token may be associated with one or more third-party stakeholders acting as authorized custodial parties who are responsible for holding the Reserve Requirement assets collateralizing the Unique Token. A relational database for such a configuration may include at least two data structures respectively associated with the authorized custodial party (e.g., a financial institution) and the underlying token basket (e.g., as provided by the central entity). In some embodiments, the database is implemented as a blockchain ledger, which may be public or private. In some embodiments, the database and/or blockchain ledger additionally include Transaction and reference numbers (e.g., for the custodial party to verify information about the Asset Mix via the central entity). For example, concurrent with a token Issuance, the custodial party may be a financial institution that is defined in the ledger and responsible for facilitating the token Issuance such as by issuing tokens to customers, purchasing collateral assets satisfying a Reserve Requirement, maintaining Transaction and reference numbers, and more.

In some embodiments, a third-party stakeholder (e.g., acting as an authorized custodial party) may be a Reserve custodial party, a Unique Token custodial party, a different custodial party, or any combination thereof. In some embodiments, a Reserve custodial party may hold Reserve assets. In some embodiments, a Unique Token custodial party may hold one or more types of Unique Tokens on behalf of owners. In some embodiments, the Reserve custodial party holds one or more sets of Reserves corresponding to each Reserve Requirement for each Unique Token held by the Reserve custodial party. In some embodiments, the Reserve custodial party holds one or more sets of Reserves corresponding to one or more Unique Tokens owned by a single Unique Token holder.

In some embodiments, a token holder may request to transfer a quantity of tokens from a first custodial party to a second custodial party. In some embodiments, in response to the transfer a first ledger may be updated to reduce the token holder's quantity of tokens with the first custodial party and a second ledger may be updated to increase the token holder's quantity of tokens with the second custodial party. In some embodiments, a single ledger indicates that the token holder's quantity of tokens has been transferred from the first custodial party to the second custodial party.

In some embodiments, the central authority may transfer a quantity of tokens from a first custodial party to a second custodial party, which may occur at the directive of the central entity such as in response to the first custodial party losing authorization. In some embodiments, the central authority may update internal records to reflect a change in the custodial party of a Unique Token, such as in response to the custodial party demonstrating increased or decreased capability to act in a custodial capacity.

The following is a representative discussion of how multiple third-party stakeholders may coordinate with the central entity to transact and hold multiple Unique Tokens and the underlying Reserve Requirements. In this example, the respective third-party stakeholders (e.g., financial institutions), including token holders therein, may freely and bidirectionally trade Unique Tokens. In response to each Transaction, one or more internal ledgers (e.g., ledgers hosted by the central entity and/or the respective third-party stakeholder) may be updated to store a record of the Transaction or a Transaction request log. With a certain regular frequency (e.g., daily), the one or more internal ledgers may be reconciled (i.e., any outstanding debits/credits are reconciled) such that the central entity and/or each respective third-party stakeholder holds the proper amount of each Unique Token. In response to each internal ledger being reconciled, each responsible party for each internal ledger (e.g., the central entity and/or each respective third-party stakeholder, including authorized custodial parties) may purchase, sell, or otherwise ensure the holding of Reserve assets in satisfaction of the net Reserve Requirements across all Unique Tokens held by the responsible party.

In some embodiments, iterative optimization algorithms are applied to efficiently reconcile data at the certain regular frequency. For example, the central authority may map all custodial parties according to outstanding debits/credits wherein relative locations on the map correspond to amounts of debit or credit. Subsequently, the central authority may execute an iterative algorithm (e.g., greedy algorithm, stochastic gradient descent algorithm, evolutionary algorithm, brute-force algorithm) that converges all custodial debits or credits to zero (i.e., that reconciles all ledgers and directs all reconciliatory payments).

In some embodiments, authorized custodial parties send and complete Transaction requests with other authorized custodial parties. The sending and completion of requests may occur automatically in response to the request by a token holder. In some embodiments, at least one of the sending or receiving custodial parties confirm proper execution of the Transaction with the central entity, and one or more internal ledgers at the central entity are thereupon updated by the central entity.

In the following example, data structures and systems are provided for transferring tokens. In response to a request to transfer tokens, a central entity generates a request identification and records it on a blockchain. In some embodiments, the central entity records the request identification and corresponding Transaction using an InterPlanetary File System (IPFS) or similar data sharing protocol. In some embodiments, the data stored by the central entity is hashed, such as for digital verification of encryption, and the central entity associates the hashed data with one or more batch Transactions. To inspect the value of a prior request or Transaction, the central authority may use the request identification to find the corresponding batch Transaction and subsequently return the associated hashed data.

It will be understood that capitalized and/or defined terms contained in the present disclosure are applicable to some embodiments. In some embodiments, capitalized and/or defined terms may take on different meaning.

1. A computer-implemented method performed by a central entity for coordinating data exchange between entities on a distributed network of nodes that persistently store transaction data based on a value of a token associated with the distributed network, wherein the central entity is coupled to the distributed network, the method comprising:
storing, in storage equipment at the central entity, respective quantities for a plurality of instruments;
receiving, from a plurality of servers over one or more data communication channels, information about the plurality of instruments;
calculating, using processing circuitry, a value of the token based on the respective quantities of the plurality of instruments and on the information;
receiving, from the plurality of servers over the one or more data communication channels, updated information about the plurality of instruments;
updating, using processing circuitry, the value of the token based on the updated information; and
providing the value of the token to one or more nodes of the distributed network for use in a transaction.

2. The method of claim 1, wherein storing the quantities for the instrument of the plurality of instruments comprises storing a quantity of zero for a respective instrument of the plurality of instruments.

3. The method of claim 1, wherein the central entity comprises at least one node of the distributed network of nodes.

4. The method of claim 1, wherein the plurality of instruments comprises at least two of: currency, commodities, securities, tangible assets, asset-backed cryptocurrencies, or any combination thereof.

5. The method of claim 1, wherein the information about the plurality of instruments comprises a market value associated with at least one of the plurality of instruments.

6. The method of claim 1, further comprising determining the quantities for the plurality of instruments.

7. The method of claim 1, further comprising monitoring a plurality of underlying assets collateralizing the token with respect to ensuring that a reserve requirement of the token is satisfied.

8. The method of claim 1, wherein the receiving of the information comprises receiving the information from sources in different time zones, and wherein the calculating is further based on different time zones.

9. The method of claim 1, wherein the value of the token is particular to the respective plurality of instruments.

10. The method of claim 1, wherein the central entity creates multiple instances of a plurality of instruments.

11. The method of claim 1, wherein one or more tokens are associated with the plurality of instruments.

12. The method of claim 1, wherein the updated information received for a plurality of instruments causes a change of the respective quantities of the plurality of instruments and, in response to changing the respective quantities of the plurality of instruments, causes an automatic change of the reserve assets collateralizing the token.

13. The method of claim 1, wherein the central entity is located on at least one of a private or public distributed network of nodes.

14. The method of claim 1, wherein the token is of a first type, the method further comprising exchanging other tokens of a second type for tokens of the first type based on an associated exchange rate.

15. The method of claim 1, wherein the token is redeemable for the plurality of instruments.

16. The method of claim 1, wherein the token is redeemable for an equivalent value in units of a single instrument that may or may not be in the plurality of instruments.

17. The method of claim 1, wherein in response to providing the value of the token, a buyer purchases a right to the token over the distributed network, and in response to the right to the token being purchased, the central entity allocates reserve assets collateralizing the token.

18. A system for coordinating data exchange between entities on a distributed network of nodes that persistently store transaction data based on a value of a token associated with the distributed network, wherein the system is coupled to the distributed network, the system comprising:
storage equipment to store respective quantities for a plurality of instruments;
a transceiver to receive, from a plurality of servers over one or more data communication channels, information about the plurality of instruments; and
processing circuitry to calculate a value of the token based on the respective quantities of the plurality of instruments and on the information,
wherein the transceiver is further to receive, from the plurality of servers over the one or more data communication channels, updated information about the plurality of instruments, and wherein the processing circuitry is further for:
updating the value of the token based on the updated information, and providing the value of the token to one or more nodes of the distributed network for use in a transaction.

19. The system of claim 18, wherein the processing circuitry is further used for determining a quantity for an instrument of the plurality of instruments, comprising determining a quantity of zero for the instrument.

20. The system of claim 18, wherein the system comprises at least one node of the distributed network of nodes.

21. The system of claim 18, wherein the plurality of instruments comprises at least two of: currency, commodities, securities, tangible assets, asset-backed cryptocurrencies, or any combination thereof.

22. The system of claim 18, wherein the information comprises a market value associated with at least one of the plurality of instruments.

23. The system of claim 18, wherein the processing circuitry is further used for determining the quantities for the plurality of instruments.

24. The system of claim 18, wherein the processing circuitry is further used for monitoring a plurality of underlying assets collateralizing the token with respect to ensuring that a reserve requirement of the token is satisfied.

25. The system of claim 18, wherein the instruments are associated with different time zones and wherein the processing circuitry is used for calculating the value of the token based on the different time zones.

26. The system of claim 18, wherein the value of the token is particular to the respective plurality of instruments.

27. The system of claim 18, wherein the distributed network of nodes stores multiple instances of a plurality of instruments.

28. The system of claim 18, wherein one or more tokens are associated with the plurality of instruments.

29. The system of claim 18, wherein the processing circuitry causes a change of the respective quantities of the plurality of instruments and, in response to changing the respective quantities of the plurality of instruments, causes an automatic change of the reserve assets collateralizing the token.

30. The system of claim 18, wherein the distributed network of nodes is located on at least one of a private or public distributed network of nodes.

31. The system of claim 18, wherein the token is of a first type, the system further comprising exchanging other tokens of a second type for tokens of the first type based on an associated exchange rate.

32. The system of claim 18, wherein the token is redeemable for the plurality of instruments.

33. The system of claim 18, wherein the token is redeemable for an equivalent value in units of a single instrument that may or may not be in the plurality of instruments.

34. The system of claim 18, wherein in response to providing the value of the token, a buyer purchases a right to the token over the distributed network, and in response to the right to the token being purchased, the central entity allocates reserve assets collateralizing the token.

35. A non-transitory computer readable medium having instructions programmed thereon for performing a method for coordinating data exchange between entities on a distributed network of nodes that persistently store transaction data based on a value of a token associated with the distributed network, wherein a central entity is coupled to the distributed network, the method comprising:
storing, respective quantities for a plurality of instruments;
receiving, from a plurality of servers over one or more data communication channels, information about the plurality of instruments;
calculating, the value of the token based on the respective quantities of the plurality of instruments and on the information;
receiving, from the plurality of servers over the one or more data communication channels, updated information about the plurality of instruments;
updating, the value of the token based on the updated information; and
providing, the value of the token to one or more nodes of the distributed network for use in a transaction.

36-105. (canceled)
